(19) United States
(12) Patent Application Publication
(10) Pub. No.: US 2024/0199478 A1
(43) Pub. Date: Jun. 20, 2024

(54) High Optical Transmission Amphiphobic Surfaces; and Methods of Forming Them

(71) Applicant: UCL BUSINESS LTD, London (GB)

(72) Inventors: Manish Tiwari, London (GB); Vikaramjeet Singh, London (GB)

(21) Appl. No.: 18/279,239

(22) PCT Filed: Mar. 2, 2022
(86) PCT No.: PCT/EP2022/055317

§ 371 Date: Aug. 29, 2023

(30) Foreign Application Priority Data
Mar. 5, 2021 (GB) 2103114.1

(51) Int. Cl. C03C 17/28; C08K 5/56; C09D 5/16; C09D 183/04

(52) U.S. Cl. CPC C03C 17/28; C09D 5/1625; C09D 5/1675; C09D 183/04; C03C 2217/76; C03C 2218/32; C08K 5/56

(57) ABSTRACT

Described are substrates having an amhiphobic surface coating. the surface coating comprising a Metal-Organic Framework (MOF) film wherein: (i) a first surface of the MOF film is bonded to the substrate: (ii) a second surface of the MOF film is an outer surface, functionalized with a plurality of surface functionalization groups; wherein: the MOF film comprises a MOF, the MOF having: metal ions selected from ions of Zr, Al, Fe, Cr and Ti; and multivalent linker groups having a structure according to formula (I): wherein A is a C₅₋₂₆ aryl group, optionally substituted with one or more groups selected from amino, halo, hydroxyl, nitro, azido, and C₂₋₄ alkynyl and cyclooctynyl; L is a ligation group, each independently selected from carboxyl, hydroxyl and 5- or 6-membered heteroaryl having from 1 to 3 nitrogen heteroatoms; and n is an integer number in the range 2 to 6; the surface functionalization groups are covalently bonded to the second surface of the MOF film and are independently selected from C₁₋₄₀ alkyl groups optionally substituted with halo; C₅₋₂₀ carboaryl groups optionally substituted with C₁₋₆ alkyl and/or halo; C₅₋₂₀ cycloalkyl groups optionally substituted with C₁₋₆ alkyl and/or halo; silyl-C₁₋₄₀ alkyl groups optionally substituted with halo; and polydimethylsiloxane oligomers having from 5 to 50 repeating units; the MOF film having an average thickness in the range 50-500 nm; and the surface coating having an optical transmission of greater than 75% to light having a wavelength in the range 400-700 nm. Also described are methods of forming such coatings using a layer-by-layer deposition process.

### FIELD OF THE INVENTION

The present invention relates to substrates coated with a high optical transmission amphiphobic coatings and methods for making such coated substrates.

### BACKGROUND

Transparent amphiphobic surfaces, with an ability to repel low surface tension liquids, are of great interest in applications such as self-cleaning, antifouling, window panes, wind screens, water harvesting, condensation, anti-icing etc (Deng et al., 2012; Yong et al., 2017). On superamphiphobic surfaces, exploiting micro/nanoscale roughness engineering, simultaneously achieving all-round robustness and transparency is nontrivial because enhancing roughness improves liquid repellency but worsens the transparency (Maitra et al., 2014). Despite notable reports on transparent superamphiphobic surfaces (Wang et al., 2016; Chen at al., 2020; Li et al., 2019), impalement resistance has so far been relatively limited (Teisala at al., 2018).

Closeness of surface asperities helps with (surface energy enabled) impalement resistance (due to smaller capillary radius) (Maitra et al., 2014), however, it is challenging to produce mechanically robust nanotextures with a few-nanometre manufacturing precision, even with compromises in fabrication scalability. Alternatives such as liquid infused or ultra-smooth surfaces show low contact angle hysteresis and slippery behaviour but are not resistant to high-speed liquid impact. Recently Wang et al. developed an armour strategy to achieve mechanically robust, transparent superhydrophobic surfaces, however, amphiphobicity was not considered (Wang et al., 2020).

Surface-grown metal-organic frameworks (MOFs) are known (Kalmutzki et al., 2018; Dang et al., 2018). However, hydrolytic susceptibility and moisture sensitivity of such MOF particles and powders is a well-known challenge and is widely researched. Typically, three strategies are used to overcome the challenge: MOF powders using fluorinated linkers in MOF synthesis, post-synthetic modification with suitable hydrophobic monolayer, and coating hydrophobic polymers coatings (Jayaramaulu et al., 2019). Such hydrophobic MOFs have been exploited for a diversity of applications in energy storage, catalysis enhancement and oil/water separation (Mukherjee et al., 2019). However, their full potential remains underutilised due to their brittle nature and the poor processability of the powder form.

Roy et al., 2016 coated the ethanolic dispersion of Zn based hydrophobic MOFs onto glass substrate by immersion and showed self-cleaning performance.

Sun et al., 2019 physically adsorbed the hydrophobic UIO-66 MOF onto glass slides to record the contact angles.

These prior works on applications of hydrophobic MOF structures lack the basic requirement of mechanical stability and have relied on the MOF particles physically adsorbed on the substrates.

On the other hand, surface-grown thin films of MOFs have been only been explored for semiconductor devices, optical sensors and gas sensors applications (Xiao et al., 2020), such applications have not sought to modify the surface of the MOF to make a transparent hydrophobic, or amphiphobic surface.

Gao et al., 2019 infused such surface-grown hydrophilic MOFs with water repellent lubricants to obtain slippery liquid infused porous surfaces (SLIPS) with low contact angle hysteresis and anti-icing characteristics. However, such SLIPS based surfaces are susceptible to depletion of the lubricant liquid, with considerable efforts being directed to overcome this issue (Chapman et al., 2020). Additionally, achieving high-speed liquid impact resistance and high mobility of sliding drops on such SLIPS surfaces is a major challenge (Peng et al., 2018).

Moreover, these surface coatings which have incorporated MOFs each suffer from low optical transmission and so are inappropriate for uses which require visibility through the substrate, for example in window panes or windscreens.

There remains a need for coatings that address one or more of these challenges. For example, there is a desire in the art for improved robust, high optical transmission amphiphobic surfaces in general.

The surfaces presented here overcome these key challenges.

### SUMMARY OF THE INVENTION

The present proposals provide a substrate having an amphiphobic surface coating, the surface coating comprising a Metal-Organic Framework (MOF) film wherein:
(i) a first surface of the MOF film is bonded to the substrate;
(ii) a second surface of the MOF film is an outer surface, functionalized with a plurality of surface functionalization groups;
   wherein:
the MOF film comprises, or in some aspects consists of, a MOF, the MOF having:
   metal ions selected from ions of Zr, Al, Fe, Cr and Ti; and
   multivalent linker groups having a structure according to formula (I):

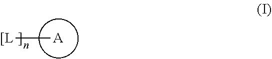

wherein A is a C₅₋₂₆ aryl group, optionally substituted with one or more groups selected from amino, halo, hydroxyl, nitro, azido, and C₂₋₄ alkynyl and cyclooctynyl;
L is a ligation group, each independently selected from carboxyl, hydroxyl and 5- or 6-membered heteroaryl having from 1 to 3 nitrogen heteroatoms; and
n is an integer number in the range 2 to 6;
the surface functionalization groups are covalently bonded to the second surface of the MOF film and are independently selected from C₁₋₄₀ alkyl groups optionally substituted with halo; C₅₋₂₀ carboaryl groups optionally substituted with C₁₋₆ alkyl and/or halo; C₅₋₂₀ cycloalkyl groups optionally substituted with C₁₋₆ alkyl and/or halo; silyl-C₁₋₄₀ alkyl groups optionally substituted with halo; and polydimethylsiloxane oligomers having from 5 to 50 repeating units;
the MOF film having an average thickness in the range 50-500 nm; and
the surface coating having an optical transmission of greater than 75% to light having a wavelength in the range 400-700 nm.

Such amphiphobic surface coatings demonstrate the desirable combination of being robust, amphiphobic and having a high optical transmission.

The present proposals also provide methods of producing a substrate having an amphiphobic surface coating, the method comprising the following steps, in order:
(i) providing a substrate;
(ii) forming a first MOF layer which is bonded to the substrate;
(iii) removing unreacted reagents;
(iv) forming a further MOF layer on the existing MOF layer;
(v) removing unreacted reagents;
(vii) contacting the MOF film with a surface functionalization reagent to covalently bond surface functionalization groups to the outer surface MOF layer of the MOF film;
each MOF layer comprising a MOF, the MOF having:
   metal ions selected from ions of Zr, Al, Fe, Cr and Ti; and
   multivalent linker groups having a structure according to formula (I):

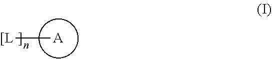

wherein A is a C₅₋₂₆ aryl group, optionally substituted with one or more groups selected from amino, halo, hydroxyl, nitro, azido, and C₂₋₄ alkynyl and cyclooctynyl;
L is a ligation group, each independently selected from carboxyl, hydroxyl and 5- or 6-membered heteroaryl having from 1 to 3 nitrogen heteroatoms; and
n is an integer number in the range 2 to 6;
the surface functionalization groups being independently selected from C₁₋₄₀ alkyl groups optionally substituted with halo; C₅₋₂₀ carboaryl groups optionally substituted with C₁₋₆ alkyl and/or halo; C₅₋₂₀ cycloalkyl groups optionally substituted with C₁₋₆ alkyl and/or halo; silyl-C₁₋₄₀ alkyl groups optionally substituted with halo; and polydimethylsiloxane oligomers having from 5 to 50 repeating units.

Such methods represent a beneficial layer-by-layer formation of the amphiphobic surface coating which provides beneficial control over both the thickness and the surface roughness of the MOF film. This control is advantageous because it allows control of the surface properties and the optical transmittance as explained herein.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1. Schematic showing layer-by-layer approach to obtain nanohierarchical MOFs on 3-aminopropyl-triethoxysilane (APTES) functionalized glass through covalent amide linkage.

FIG. 2. Powder X-Ray Diffraction (PXRD) graph of MOF film of Example 2.

FIG. 3. Raman spectrum of glass functionalized with APTES and after MOFs growth (Example 2) showing bonding of MOF to APTES functionalisation and chemical structure of the hydroxylated Zr-MOFs.

FIG. 4. FTIR spectra of MOF confirming the chemical structure.

FIG. 5. Elemental mapping of representative elements on the hydrophobic MOF surface modified with alkyl silane, showing broad distribution of Zr, Si and O, and low amounts of Cl.

FIG. 6. SEM micrographs tracking MOF growth with increasing number of repeated growth cycles: (A) 1 cycle (B) 2 cycles (C) 4 cycles (D) 5 cycles.

FIG. 7. SEM images at higher magnifications showing uniform MOF particles.

FIG. 8. Morphology characterization of MOF film at different concentrations of organic linker and metal source for synthesis optimization. SEM image MOF films (A) at low (10 mM) concentration of organic linker and metal, recorded after 10 cycles, and (B) at 50 mM concentration, after 4 cycles and (C) after 10 cycles, grown without APTES functionalization.

FIG. 9. Cross-sectional SEM image of MOF layer on glass.

FIG. 10. High-resolution TEM image of MOF cluster showing porous frameworks with approximately 1 nm pore size. The highly aligned crystal lattice structures are marked with dashed ellipse.

FIG. 11. Top: 3D topography confirming nanoscale rough structures recorded by AFM. The larger nanoscale features combined with much smaller MOF pores (˜1-nm scale) provide the nanohierarchical morphology. Bottom: The cross-sectional view of the nanostructure heights recorded along lines 1 and 2 (middle).

FIG. 12. Transparency and wetting hysteresis for varying number of repeated cycles of growth of MOF (Layers), arrows indicate which axis corresponds to which data series.

FIG. 13. Photograph showing the visual change in transparency of glass slides with the increasing number of MOF growth cycles (layers).

FIG. 14. Optical transparency of different samples.

FIG. 15. Advancing and receding angle measurement of a water droplet.

FIG. 16. Effect of silane chain length on water advancing, receding and hysteresis angles. Insets illustrate the silane chains.

FIG. 17. Photographs capturing water and vegetable oil droplets sliding at 15° surface tilt. Image sequence showing the amphiphobicity of the nanohierarchical surface through sliding of low surface tension liquids at 15° tilt angles. The low surface tension liquids (Butanone to 1-Butanol) are arranged with increasing viscosity (from top to bottom), which affects the sliding speed (part 1). Sliding of further low surface tension liquids at 15° tilt angles on nanohierachical MOF surface (part 2). Each row corresponds to a different liquid, the left-hand column showing a droplet of the liquid at a first position at t=0 and the right-hand column showing the droplet after sliding to a second position in the time shown on the time stamp.

FIG. 18. Self-cleaning process of surface showing dirt removal by sliding water droplets.

FIG. 19. Drop sliding speeds on the amphiphobic nanohierarchical MOFs compared with theoretical velocities and those measured on a comparative SLIPS surface.

FIG. 20. Diagrammatic representation of water jet impact experiments.

FIG. 21. SEM image showing unchanged morphology of MOF-on-glass surface after repeated jet impact test.

FIG. 22. A series of snapshots showing free sliding of droplet on a coated surface after jet impact test. (A) A water droplet placed at the area repeatedly impacted by high-speed jet at 35 m/s and tilted slowly (B and C). Scale bar is 5 mm.

FIG. 23. Schematic of the setup used to test the retention of hydrophobicity. Both nanohierarchical MOF surface and the corresponding MOF based SLIPS were tested with same protocol.

FIG. 24. Comparative change in contact angle hysteresis through continuous dripping of water droplets.

FIG. 25. Tape peel test to check the adhesion of MOF layer to the glass. (A) A MOF coated glass slide fixed with transparent tape and (B) application of strong adhesive tape on MOF on glass substrate

FIG. 26. The effect of tape peel cycles; θ_{A}, θ_{R} and Δθ remained unchanged even after 50 repeated cycles.

FIG. 27. Time-lapse snapshots from drop impact test (1.2 m/s) on a nanohierarchical MOF surface after 50 tape peel cycles. Scale bar is 2 mm.

FIG. 28. SEM micrograph of the MOF surface after 50 repeated tape peel cycles.

FIG. 29. Pencil hardness test. (A) The nanohierarchical MOF surface showing marks left by standard scratch test performed using pencils of different hardness, marks are shown for pencils of hardness 5H to HB, with the most clearly visible marking from the 5H pencil and the least clearly visible marking from the HB pencil (B) the pencil marks disappeared after gentle cleaning of the surface with tissue paper. (C-D) A full cycle of pushing the pencil at ˜45° on the MOF surface and (E) the close photograph of flattened pencil lead before and (F) after test. Scale bar is 1 cm (A-D) and 1 mm (E-F).

FIG. 30. Acid-base stability. (A) Effect of immersion in acidic pH (1-2), the non-wetting features are maintained for 1 month (700 hours), when hysteresis slightly increased from 10° to 15°. (B) The base stability graph showing the change in contact angles (θ_{A} and Δθ) on MOF on glass surface. The surface was immersed into basic solution of pH=11-12 and subjected to contact angle measurement at predetermined time intervals.

FIG. 31. Thermal stability test of the surface. Top row of data points relates to the advancing contact angle for water, the middle row of data points relates to the measured sliding speed (as indicated by the arrow), the bottom row of data points relates to the measured contact angle hysteresis.

FIG. 32. Time lapse snapshots (scale=2 mm) of drop impact on the nanohierarchical slippery MOF surfaces at 1.4 m/s impact velocity.

FIG. 33. Time lapse snapshots (scale=2 mm) of drop impact on the nanohierarchical slippery MOF surfaces at 4.2 m/s impact velocity.

FIG. 34. Time-lapse snapshots of drop impact on silanized glass surfaces taken as a control. The surface showed no bouncing even at low velocity of 1.2 m/s.

FIG. 35. A schematic of the ice adhesion measurement setup. During each cycle tested, 3 cuvettes were placed on the glass slide (with or without MOF) under test and filled with water following by freezing at −35° C. for 1 hr and then pushed with moving rod. The recorded forces were used to calculate the adhesion strength (kPa) by dividing the force with Cuvette cross-sectional area.

FIG. 36. Ice adhesion strength of different treatments on glass substrate including bare glass as a control, glass functionalized with trichlorooctadodecyl silane (OTS), ultra-smooth surface based on polydimethylsiloxane oligomers (SOCAL) and the nanohierarchical MOF surfaces described herein.

FIG. 37. Change in the ice adhesion strength of the MOF surface up to 15 repeated icing/de-icing cycles.

FIG. 38. Pollutant adsorption in the MOF surface, main graph shows rhodamine B adsorption; benzene and toluene cases are shown in inset.

FIG. 39. Rhodamine B, benzene and toluene absorbance fit to pseudo-second order kinetics

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Definitions

As discussed herein, amphiphobic behaviour is the repulsion of both aqueous and non-aqueous liquids, such as water, and low surface tension liquids, such as alcohols and ketones. As such, an amphiphobic surface is one that exhibits repulsion towards both aqueous and non-aqueous liquids. Such amphiphobic repulsion behaviour can be observed, for example, from the sliding behaviour of such liquids when placed on the surface at an angle inclined to horizontal.

As used herein, the term “MOF” means metal-organic framework. MOFs are organic-inorganic hybrid crystalline porous materials in which a regular array of positively charged metal ions are linked together by organic ‘linker’ molecules. The metal ions form nodes where the linker molecules bind to form a repeating, cage-like structure enclosing pores.

As used herein a “ligation group” is a chemical functional group that bind to or otherwise associate with a metal ion in the MOF to effectively join the linker unit to that metal ion.

As used herein a MOF “layer” comprises a layer of metal ions bonded to linker groups. Therefore, a two layer coating comprises two deposited layers of metal ions (M) each bonded to linker groups (L), i.e. outwards from the substrate L-M-L-M-L.

### Substrates

The substrates used herein for coating with an amphiphobic surface coating are reactive to a MOF layer or are functionalizable to be made reactive to a MOF layer.

For example, the substrate may contain functional groups on its surface that are capable of bonding to the metal ions or linker molecules of the MOF. Alternatively, the substrate surface can be reacted with a priming reagent to obtain functional groups that are capable of bonding to the metal ions or linker molecules of the MOF.

Functional groups which are capable of bonding to the metal ions or linker molecules may be, for example amino groups, alcohol groups, thiol groups or carboxyl groups.

In one embodiment, the substrate permits high optical transmission. For example, the optical transmission of the substrate is greater than 90% to light having a wavelength in the range 400-700 nm. In a preferred embodiment, the substrate is a transparent material, such as glass or a transparent polymer (e.g. low density polyethylene (LDPE), high density polyethylene (HDPE), polyurethane (PU), polyethylene terephthalate (PET), polycarbonate (PC), polymethylmethacrylate (PMMA)).

Preferably, when the substrate is glass, a priming reagent is used to provide functional groups which are reactive to the MOF layer on the surface of the glass. For example, a glass surface may be primed with 3-aminopropyltriethoxy silane (APTES) to provide amino groups on the surface of the glass.

Providing a layer of functional groups which are reactive to the MOF (metal ion or linker) on the surface of the substrate is advantageous to obtain a firmly attached and uniform MOF film. Alternatively this surface attachment may be achieved by using an intermediate layer between the surface and the MOF film, such as an adhesive layer that has good adhesion to the substrate surface and has surface groups that are reactive to the MOF (metal ion of linker). Without wishing to be bound by theory, a firmly attached and uniform MOF film is an important feature for obtaining a robust surface coating which is resistant to surface impalement.

### MOF Layers

MOFs suitable to form MOF layers as defined herein are selected and/or designed to provide robust surface coatings. The nature of the MOF may also contribute to the surface properties of the surface coating, e.g. the amphiphobic nature. Furthermore the nature of the MOF may also influence the optical transmittance of the surface coating, for example MOFs utilizing certain specific metal ions or certain specific linker groups may form a surface coating having reduced optical transmittance, e.g. below that desired in the present proposals.

The MOF must be chosen such that it has functional groups available to bond with the substrate surface. Additionally, the MOF must be suitable to be functionalized after synthesis of the MOF layers.

Preferably, the MOF has an average pore size of 3 nm or less, more preferably the average pore size is 2.6 nm or less, most preferably the pore size is about 2.1 nm, or about 1 nm. Without wishing to be bound by theory, a small average pore size (e.g., less than 3 nm) results in a higher capillary pressure when a liquid is applied to the surface. Thus, liquid meniscus penetration is resisted and this reduces solid-liquid contact. Therefore, easy sliding of droplets on the surface of the MOF and a low contact angle hysteresis is facilitated. This also improves liquid impact resistance.

In some embodiments, the MOF may have a shear modulus of greater than 10 GPa. Without wishing to be bound by theory, the higher the shear modulus of a MOF, the less brittle particles of the MOF will be. This is desirable for the present invention as a less brittle MOF will be more robust when applied as a coating layer.

In some embodiments, the metal ions in the MOF may on average be coordinated by 10 or more linkers. The coordination number of the metal ion in the MOF is dependent on the chemical nature of the coordination complex. The skilled person is capable of selecting MOFs having the required coordination number. Without wishing to be bound by theory, the greater the coordination number of the metal ion, the higher the shear modulus of the MOF will be. Therefore, a MOF having a high coordination number (e.g. greater than 10) is desirable for the same reasons as a MOF that has a high shear modulus (e.g. greater than 10 GPa).

### Metal Ions

Preferably, the metal ion of the MOF is selected from an ionized form of one of the following metals: zirconium (Zr), zinc (Zn), iron (Fe) and copper (Cu). For example, the metal ion may be Zr³⁺, Zr⁴⁺, Zn²⁺, Fe²⁺, Fe³⁺, Cu⁺, or Cu²⁺. Most preferably, the metal ion is Zr⁴⁺. Preferably the MOF comprises only a single type of metal ion.

The skilled person is aware of appropriate metal salts which may be used to obtain the required metal ions. For example, the respective metal halide may be used. The metal ion may be derived from a metal salt selected from ZrCl₄, ZnCl₂, FeCl₃, FeCl₂, CuCl, and CuCl₂.

### Linkers

The linker units used herein are multivalent linker groups having a structure according to formula (I):

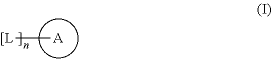

wherein A, L and n are as defined herein.

The group A is a C₅₋₂₆ aryl group. In some cases, A is selected from C₆₋₁₈ aryl. In some cases, A is selected from phenyl, naphthalene, biphenyl, fluorene, anthracene, phenanthrene, phenalene, terphenyl, tetracene, chrysene, triphenylene, pyrene, pentacene, perylene, benzo[a]pyrene, corannulene, and coronene.

In some cases, A comprises two or more C6 phenyl rings linked together by single bonds; preferably the two or more phenyl rings are bonded together in a linear manner. In some cases, A is selected from phenyl, biphenyl, and terphenyl (preferably para-terphenyl).

The A group may optionally be substituted with one or more groups selected from amino, halo, hydroxyl, nitro, azido, and C₂₋₄ alkynyl and cyclooctynyl; preferably the optional substituents are selected from amino and hydroxyl.

The group L is a ligation group each of which is independently selected from carboxyl, hydroxyl and 5- or 6-membered heteroaryl having from 1 to 3 nitrogen heteroatoms. The 5- or 6-membered heteroaryl having from 1 to 3 nitrogen heteroatoms may be, for example, pyrrole, imidazole, pyrazole, triazole, pyridine, diazine, and triazine. Preferably the ligation groups are each selected from carboxyl and hydroxyl; preferably carboxyl. Preferably all of the ligation groups in the linker group are the same.

The integer n defines the number of ligation groups attached to each A group and is in the range 2-6. Preferably n is 2 or 3; preferably 2.

Preferably the linker group is selected from benzodicarboxylic acid, biphenyldicarboxylic acid, or terphenyldicarboxylic acid; optionally substituted with one or more groups selected from amino, halo, hydroxyl, nitro, azido, and C₂₋₄ alkynyl and cyclooctynyl; preferably the optional substituents are selected from amino and hydroxyl.

Preferably, the linker is selected from one of the following molecules: 1,4-benzodicarboxylic acid, 4,4″-biphenyldicarboxylic acid and p-terphenyl-4,4″-dicarboxylic acid, optionally the linker is substituted with one or more groups selected from OH and NH₂.

For example, the linker may be selected from: 2,5-dihydroxy-1,4-benzenedicarboxylic acid, 2,5-diamino-1,4-benzenedicarboxylic acid, 2,2′-dihydroxy-4,4′-biphenyldicarboxylic acid, 3,3′-dihydroxy-4,4′-biphenyldicarboxylic acid, 2,2′-diamino-4,4′-biphenyldicarboxylic acid, 3,3′-amino-4,4′-biphenyldicarboxylic acid, 2,2″-dihydroxy-p-terphenyl-4,4″-dicarboxylic acid, 2,2″-diamino-p-terphenyl-4,4″-dicarboxylic acid, 3,3″-dihydroxy-p-terphenyl-4,4″-dicarboxylic acid, 3,3″-diamino-p-terphenyl-4,4″-dicarboxylic acid, and 2′,5′-dihydroxy-[1,1′:4′,1″]-terphenyl-4,4″-dicarboxylic acid.

Most preferably, the linker is 2,5-dihydroxy-1,4-benzenedicarboxylic acid.

### Metal Ion Linker Combinations

Preferably the combination of metal ion and linker is chosen to generate one of the following MOFs: Zr(UiO-66-OH) [that is, Zr⁴⁺ with 2,5-dihydroxy-1,4-benzenedicarboxylic acid linker], Zr(UiO-66-NH₂) [that is, Zr⁴⁺ with 2,5-diamino-1,4-benzenedicarboxylic acid linker or with 2-aminoterepthalic acid], Zr(UIO-67-OH) [that is, Zr⁴⁺ with 3,3′-dihydroxy-4,4′-biphenyldicarboxylic acid linker], Zr(UIO-67-NH2) [that is, Zr⁴⁺ with 3,3′-amino-4,4′-biphenyldicarboxylic acid linker], Zr(UiO-68-OH) [that is, Zr⁴⁺ with 3,3″-dihydroxy-p-terphenyl-4,4″-dicarboxylic acid linker], and Zr(UiO-68-NH2) [that is, Zr⁴⁺ with 3,3″-diamino-p-terphenyl-4,4″-dicarboxylic acid linker].

Most preferably, the metal ion and linker is chosen to generate the MOF Zr(UiO-66-OH), that is Zr⁴⁺ with 2,5-dihydroxy-1,4-benzenedicarboxylic acid linker.

### Solid Fraction

The solid fraction of the MOF surface (˜0.4) is preferably low compared with a smooth hydrophobic surface (which is typically about 1). This helps to achieve low contact angle hysteresis and sliding angles for water and other low surface tension liquids on the MOF surface compared with smooth hydrophobic surfaces.

The solid fraction, ϕ, of MOF is estimated by known methods, by considering the geometry of the MOF pores and the corresponding unit cell.

### Surface Functionalization Groups

The surface coating comprises pendant groups attached to the outer surface of the coating. Said pendant groups are described herein as surface functionalization groups. The surface functionalization groups are hydrophobic, for example, they do not form hydrogen bonds with water.

The surface functionalization groups used herein are selected from: C₁₋₄₀ alkyl groups optionally substituted with halo; C₅₋₂₀ carboaryl groups optionally substituted with C₁₋₆ alkyl and/or halo, C₅₋₂₀ cycloalkyl groups optionally substituted with C₁₋₆ alkyl and/or halo, silyl-C₁₋₄₀ alkyl groups optionally substituted with halo; and polydimethylsiloxane oligomers having from 5 to 50 repeating units. The optional halo substituent being selected from F, Cl, Br and I; preferably selected from F and Cl. In some cases, the optional halo substituent is Cl.

Such groups may, for example, be selected from C₆₋₂₄ alkyl, C₆₋₁₀ carboaryl, C₆₋₁₀ cycloalkyl, and silyl-C₅₋₃₀ alkyl groups; each optionally substituted as set out herein.

Preferably the surface functionalization group is selected from C₆₋₂₄ alkyl or silyl-C₆₋₂₄ alkyl, such as C₁₂₋₂₀ alkyl or silyl-C₁₂₋₂₀ alkyl, preferably, the surface functionalization group is selected from C₆ alkyl, C₁₂ alkyl, C₁₈ alkyl, silyl-C₆ alkyl, silyl-C₁₂ alkyl and silyl-C₁₈ alkyl. Preferably the surface functionalization group is selected from silyl-C₆₋₂₄ alkyl, such as silyl-C₁₂₋₂₀ alkyl, preferably, the surface functionalization group is selected from silyl-C₆ alkyl, silyl-C₁₂ alkyl and silyl-C₁₈ alkyl. Said alkyl groups, either alone or as part of an silyl-alkyl group, may be branched or linear. Preferably the alkyl groups are linear.

The polydimethylsiloxane oligomers may be linear or branched; preferably linear.

More preferably, the surface functionalization group is unsubstituted.

Most preferably, the surface functionalization group is unsubstituted linear silyl-C₁₈ alkyl.

In some preferred cases the surface functionalization groups do not contain fluorine. This provides a significant benefit in terms of reduced environmental impact.

### Bonded to the Outer Surface

The surface functionalization groups are covalently bonded to the outer surface of the surface coating (i.e. the outer MOF layer). Any suitable covalent linkage between the MOF layer and the surface functionalization groups may be used.

Functional groups such a carboxyl, amino and/or hydroxyl groups may be present near the surface of the MOF layer, for example, due to unreacted functional groups present on the linker groups. The skilled person is capable of selecting reagents to provide surface functionalization groups which are covalently attached to the outer MOF layer.

The surface functionalization groups may be attached to the surface of the MOF by reaction with functional groups on the linker groups. For example, the surface functionalization groups may be attached by reaction with the ligation groups and/or by reaction with the optional substituent groups that form part of the linker group. Preferably the surface functionalization groups are attached to the MOF surface by reaction with the optional substituent groups attached to the A groups as defined herein; preferably by reaction with carboxyl or hydroxyl units attached to the A group; more preferably by reaction with hydroxyl groups.

For example, when unreacted hydroxyl groups are present in linker groups of the outer MOF layer of the surface coating, surface functionalization groups may be covalently linked to these groups by providing the appropriate trichloro silane. Thus, the surface functionalization will be covalently attached to the MOF layer through a silyl ether linkage.

Alternatively, the linkage may be selected from other groups known to the skilled person, such as, amide, ester, ether, thioester, and thioether linkages. Most preferably the linkage is a silyl ether linkage.

### Methods of Forming Coatings

The present disclosure also includes methods of forming amphiphobic coatings as defined herein. These methods relate to formation of such amphiphobic coatings on a substrate surface. The methods disclosed herein comprise the following steps, in order:
(i) providing a substrate;
(ii) forming a first MOF layer which is bonded to the substrate;
(iii) removing unreacted reagents;
(iv) forming a further MOF layer on the existing MOF layer;
(v) removing unreacted reagents;
(vii) contacting the MOF film with a surface functionalization reagent to covalently bond surface functionalization groups to the outer surface MOF layer of the MOF film.

The substrate, MOF, and surface functionalization groups are as defined herein.

Step (ii) comprises attaching the linker group, which forms part of the MOF, to the substrate surface. This attachment may comprise direct bonding of the ligation group L (as defined herein) to the substrate surface. Alternatively, this attachment may comprise activating the surface of the substrate prior to attachment of the linker group (by application of a linker reagent). The activation of the surface of the substrate may, for example, be by treatment of a glass substrate with an amino silane functionalisation group, such as 3-aminopropyl-triethoxysilane (APTES), to provide amine groups with which the linker reagent can react. Alternatively, the attachment of the linker group to the substrate surface may comprise treatment of the substrate surface with an adhesive followed by application of the MOF linker reagent.

Preferably steps (i) and (ii) together comprise, in order:
a) Provision of a glass substrate;
b) Application of an amino silane, preferably APTES, to the glass substrate;
c) Application of a multivalent linker groups as defined herein;
d) Application of a metal salt as defined herein; and
e) Application of a multivalent linker group as defined herein.

Preferably a washing step is included between one or more pairs of steps b) and c); c) and d); and d) and e). More preferably a washing step is included between each of steps b) and c); c) and d); and d) and e). These preferred washing steps assist in controlling the growth of the MOF layer and producing the desired optical transmittance in the surface coating. In the absence of these preferred washing steps it may be found that unreacted metal and linker reagents can react in subsequent deposition cycles to negatively impact the optical transmittance of the MOF film and/or to result in non-uniform MOF deposition which can negatively impact the desired roughness of the MOF surface.

Preferably step (iv) comprises, in order:
a) Application of a multivalent linker groups as defined herein to the existing external MOF layer;
b) Application of a metal salt as defined herein; and
c) Application of a multivalent linker group as defined herein.

Preferably a washing step is included between one or more pairs of steps a) and b); and b) and c). More preferably a washing step is included between each of steps a) and b), and b) and c). These preferred washing steps assist in controlling the growth of the MOF layer.

Preferably the surface functionalization reagent in step (vii) is a reagent comprising a surface functionalization group as defined herein and a further functional group which reacts with a ligation group L (as defined herein) or reacts with an optional substituent group on an A group as defined herein; preferably the further functional group reacts with an optional substituent group (preferably a hydroxyl group) on an A group as defined herein.

Preferably one or both of steps (iii) and (v) in the methods defined herein comprise one or both of washing the MOF layer with a solvent and sonicating the MOF layer in a solvent. Preferably the solvent is dimethylformamide (DMF).

In the method defined herein the steps (iv) and (v) are preferably repeated two or more times to form a MOF film having three or more MOF layers, prior to performing step (vii). Preferably steps (iv) and (v) are repeated five or more times to form a MOF film having six or more MOF layers, prior to performing step (vii). Preferably steps (iv) and (v) are repeated between three and eight times to form a MOF film having between four and nine MOF layers, prior to performing step (vii). As noted herein, the number of layers is important as it affects a range of features of the surface coating such as the thickness of the layer, the light transmittance, and properties affecting the amphiphobicity of the surface such as the surface roughness, contact angles and also the contact angle hysteresis.

To maintain high transparency to light in the 400-700 nm range, 6 layers were optimal; beyond 8/9 layers, the transmittance started to decline.

The layer-by-layer growth of the MOF film used in the methods defined herein permits careful control of the thickness of the MOF layer which is important to achieve the high optical transmittance demonstrated by the surface coatings defined herein. In addition, this layer-by-layer growth method also permits control of surface roughness which may be beneficial in optimization of surface coating properties, particularly optical transmittance.

Preferably both the metal salt and multivalent linker group used in the MOF formation steps (ii) and (iv) of the methods defined herein are present in solution (using an appropriate solvent) at a concentration of up to 50 mM; preferably between 10 mM and 50 mM; preferably between 10 mM and 35 mM, preferably between 15 mM and 30 mM, preferably between 20 mM and 30 mM, preferably about 25 mM. At lower reagent concentrations the growth of MOF film may be slow and may result in nanometre sized but discrete, uniformly distributed particles as opposed to a preferred uniform layer. Furthermore, at lower reagent concentration the obtained surface roughness may be undesirably low even after 10-15 deposition cycles.

At higher reagent concentrations, e.g. 50 mM or higher, the MOF growth may form large clusters resulting in an undesirably uneven surface after even a relatively low number of deposition cycles (e.g. 3). At reagent concentrations in the preferred range, e.g. about 25 mM, a uniform MOF film typically forms followed by evolution of desirable surface roughness in the MOF film after a desired number of deposition cycles, e.g. 4-9 deposition cycles as noted herein.

### Coating Layer Parameters

The surface coating may be formed from a series of MOF layers. A first MOF layer is bonded to the substrate. A second MOF layer forms the outer surface of the coating layer. The first MOF layer is between the substrate and the second MOF layer. Further MOF layers may be provided between the first and the second MOF layers.

A MOF “layer” comprises a layer of metal ions bonded to linker groups. Therefore, a two layer coating comprises two deposited layers of metal ions (M) each bonded to linker groups (L), i.e. outwards from the substrate L-M-L-M-L.

Preferably, the surface coating comprises at least four MOF layers.

Preferably, the surface coating comprises less than 9 MOF layers.

Preferably the surface coating comprises 4-8 MOF layers. More preferably the surface coating comprises 5-7 MOF layer. Most preferably, the surface coating comprises 6 MOF layers.

The number of layers is important as it affects a range of features of the surface coating such as the thickness of the layer, the light transmittance, and properties affecting the amphiphobicity of the surface such as the surface roughness, contact angles and also the contact angle hysteresis.

To maintain high transparency to light in the 400-700 nm range, 6 layers were optimal; beyond 8/9 layers, the transmittance started to decline.

The surface coatings of the invention have high optical transmission properties. That is, the transmission to visible light (having a wavelength in the range 400-700 nm) is greater than or equal to 75%, preferably greater than or equal to 80%, preferably greater than or equal to 85%, preferably greater than or equal to 90%, preferably greater than or equal to 95%.

Without wishing to be bound by theory, at least two factors related to the number of layers may affect transmission of visible light through the surface coating. As the number of layers increases, so does the thickness of the coating thereby, typically, reducing optical transmission. Additionally, as the number of layers increases, so may the average roughness, thereby increasing scattering of light and therefore negatively impacting optical transmission.

Further important factors affecting optical transmittance may include the nature of the MOF components (metal ions and linker groups) with the MOFs as defined herein being particularly well suited to formation of MOF films having high optical transmittance. Careful design and selection of the nature of the MOF is important to achieve the desired high optical transmittance.

### Coating Thickness

The surface coating has an average thickness in the range of 50-500 nm. The thickness may be measured by AFM, cross-section visualisation by SEM or by ellipsometry.

Preferably, the surface coating has an average thickness in the range 60-400 nm, 70-300 nm, 100-250 nm, or 150-200 nm. Preferably the film thickness is about 200 nm as measured by cross-section visualization by SEM.

The film thickness is important to achieve the desired high optical transmittance. Films having a thickness higher than about 500 nm start to degrade in optical transmittance. Below the lower limit of about 50 nm, the films herein exhibit an undesirable decrease in robustness to mechanical damage.

### Dry Coating

In preferred aspects, the surface coatings defined herein do not require surface infusion of a liquid component to achieve the desired surface properties, e.g. amphiphobicity. Although it is not excluded that surface infusion of a liquid component could be used to alter the surface properties, possibly with retention of amphiphobicity, such infusion is not necessary to achieve the desired properties mentioned herein. Preferably the surface coating is not a SLIPS coating. The lack of any requirement for a SLIPS infusion liquid has the advantage that the surface coating may be completely dry (lacking any liquid component) and avoids any problems associated with degradation of the surface properties, e.g. via loss of the infused liquid over time or due to high energy impact such as fluid droplet impacts. Therefore, the present surface coatings typically demonstrate reduced degradation over time of the desirable surface properties, and demonstrate a greater resilience of the surface properties to mechanical stresses such as droplet impact.

### Roughness

The roughness of the surface coating is important as it can affect both the amphiphobic behavior of the surface and the optical transmission. While a certain amount of roughness is preferable to provide the amphiphobic behavior of the surface (e.g. low contact angle hysteresis), above a certain threshold, the desired amphiphobic properties may start to degrade. Additionally, high roughness may increase scattering of light which results in lower transmission through the MOF film. Root mean square surface roughness can be measured by AFM.

Preferably, the root mean square (RMS) roughness is less than 150 nm. Preferably, the RMS roughness is greater than 50 nm. Preferably, RMS roughness is in the range 50-150 nm, for example in the range 60-100 nm, such as 70-80 nm. Preferably the RMS roughness is about 74 nm.

### Contact Angles and Hysteresis

The advancing (θ_{A}) and receding (θ_{R}) contact angles of liquid droplets on a surface can be measured using a goniometer, e.g. as described in Example 6. Hysteresis (Δθ) is calculated using the formula:

(Δθ=θ_{A}−θ_{R})

Higher contact angles signify surfaces which are more repellent of the liquid for which the contact angle is measured.

Low hysteresis signifies that the advancing and receding contact angles are more similar which is indicative of low wettability and repellent behaviour.

The coated substrates described herein preferably exhibit advancing contact angles (i.e. as the droplet is being deposited on the surface and the droplet is growing in volume) for water droplets of more than 100°, preferably more than 110°. The coated substrates described herein preferably exhibit receding contact angles (i.e. as the droplet is being removed from the surface and the droplet is decreasing in volume) for water droplets of more than 100°, preferably more than 110°.

The contact angle hysteresis for water droplets on a coated substrate described herein is preferably less than 30°, preferably less than 20°, most preferably less than 10°.

### Sliding Angles

Sliding angle represents the angle of tilt above horizontal at which a droplet of liquid placed on the surface slides freely off the surface. This is an indicator of the surface repellent behaviour.

Preferably the coated substrates described herein exhibit a water droplet sliding angle of less than 20°, preferably less than 15°.

Preferably the coated substrates described herein exhibit a vegetable oil droplet sliding angle of less than 20°, preferably less than 15°.

Preferably the coated substrates described herein exhibit a sliding angle of less than 20°, preferably less than 15° for a droplet of each of water and vegetable oil.

Preferably the coated substrates described herein exhibit a sliding angle of less than 20°, preferably less than 15° for a droplet of one or more liquid selected from water, vegetable oil, butanone, ethanol, methanol, acetone, and 1-butanol.

Preferably the coated substrates described herein exhibit a sliding angle of less than 20°, preferably less than 15° for a droplet of all liquids selected from water, vegetable oil, butanone, ethanol, methanol, acetone, and 1-butanol.

### Amphiphobicity

The coated substrates described herein exhibit amphiphobicity, that is they display both hydrophobic and oleophobic properties. In some cases, the coated substrates defined herein repel both aqueous liquids and low surface tension solvents. Low surface tension solvents include, for example, butanone, ethanol, methanol, acetone, 1-butanol, 1-decanol, glycol, cyclohexanol and 1,2-butanediol, and vegetable oil.

The amphiphobicity is a result, at least in part, of the design and selection of the MOF and the surface functionalization thereof. Surface roughness may also affect the amphiphobic nature of the surface coating.

In some situations, for example when the surface functionalization groups are non-polar (e.g. unsubstituted alkyl, cycloalkyl, or silyl-alkyl), non-polar hydrocarbon solvents may be repelled to a lower degree or not repelled at all.

### Ice Adhesion

The coated substrates described herein typically exhibit low ice adhesion strength; the force required to dislodge ice from the surface of the coated substrate.

Preferably, the ice adhesion strength is less than 100 kPa. Preferably, the ice adhesion strength is less than 50 kPa. Preferably, the ice adhesion strength is about 35 kPa.

Preferably, the low ice adhesion strength is maintained throughout repeated icing/deicing cycles. Preferably low ice adhesion strength is maintained for 5 or more cycles, more preferably 10 or more cycles.

This low ice adhesion strength is particularly advantageous when using the coated substrates in applications where adhesion of ice can result in detrimental performance of the surface. For example, aviation surfaces where even small deviations from carefully designed surface morphology can be highly detrimental to aerodynamic performance. Furthermore, the ability to demonstrate this low ice adhesion in conjunction with high optical transmittance is particularly beneficial, e.g. in automobile or aviation windows and windscreens where anti-icing properties are highly desirable.

### Robustness

The coated substrates described herein are typically highly robust, i.e. they have a high resistance to mechanical damage, e.g. by deformation, impact (such as water jet impact), abrasion, or scratching.

For example, the coated substrates described herein preferably do not show signs of surface damage under SEM inspection after jet impact with water jets at speeds of greater than 35 m/s. 35 m/s is a relevant impact speed as it equates to approximately 126 km per hour (about 78 miles per hour) which is typical of the upper end of legal motorway/highway speed limits in many countries. Therefore, this demonstrates good resistance of the coated substrate to water droplet damage simulating rain or surface spray on a vehicle windscreen at common motorway/highway speeds.

Preferably, the coated substrates described herein do not show signs of surface damage under SEM inspection after repeated jet impact with water jets at speeds of greater than 35 m/s. For example, after 3 repeated jet impacts on the same spot.

The coated substrates described herein are typically resistant to peeling cycles with high-tack tape (such as 3M VHB™ 5952 having peel strengths of 3 900 N/m). After application of the tape to the coated substrate with a 2-kg roller, peeling of the tape has minimal effect on the contact angles and hysteresis measured for the coated substrate demonstrating resistance to a peeling cycle.

The coated substrate may be resistant to 10 or more, 20 or more, 30 or more, 50 or more peeling cycles. The coated substrate is preferably able to withstand scratches from pencils of hardness from HB to 5H without noticeable damage to the coating.

The hysteresis of water droplets on the coated substrate is typically not negatively impacted by the application of a large volume of droplets on a single position on the coating. That is, the coating is robust to continued exposure to sliding water droplets, for example because the coating is not depleted from the substrate by continued application of water droplets.

For example, water droplet hysteresis is typically unchanged after 500 mL, 1000 mL, 2000 mL, 3000 mL, 4000 mL, or 5000 ml of water droplets are applied to the same position on the coating.

The high robustness described herein and the exhibition of such desirable properties in conjunction with the high optical transmittance defined herein may be due, at least in part, to the selection and design of the MOF and the nature of the surface functionalization groups, along with the MOF film thickness.

### Use of the Coating

Surface coatings defined herein may also, in some cases, demonstrate pollution absorption and/or degradation properties. For example, the capability to efficiently absorb a wide range of inorganic and organic pollutants, including, demonstrated for example, with one or more test compounds selected from Rhodamine B, benzene, and toluene, with clear applications in removal of environmental pollutants.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### EXAMPLES

### Materials and Instrumentation

Microscopic glass slides (75 mm×25 mm) were purchased from Thorlabs. All the chemicals including, zirconium chloride octahydrate (ZrCl₂·8H₂O), dihydroxyterepthalic acid (DHTPA), dimethyl formamide, glycol, glycerol, ethanol, acetone, isopropanol, 1-butanol, n-hexane, butanone, 1,2-butanediol, decanol, cyclohexaneol, benzene, toluene, chloroform, dimethoxy methyl silane, 3-aminopropyltriethoxy silane (APTES), trichlorohexyl silane, trichlorododecyl silane, trichlorooctadecyl silane (OTS), rhodamine B, sodium hydroxide (NaOH), sulphuric acid (H₂SO₄), hydrochloric acid (HCl) and silicon oil (500 cSt) were purchased from Sigma Aldrich. Commercial vegetable oil was purchased from a local supermarket (Tesco). All the chemicals were used without further purification.

The surfaces morphologies were imaged using scanning electron microscopy (SEM) (Carl Zeiss EVO25) and atomic force microscopy (AFM) (Bruker ICON SPM). For SEM, the specimens were immobilized on a metal stub with double-sided adhesive carbon tape and coated with a thin gold film, then observed at 20 kV voltage and 10 pA current. The MOF coated glass was subjected to Raman spectroscopy using a Renishaw confocal microscopy in the region of 100 to 2000 cm⁻¹ to confirm their chemical structures. The PXRD of the MOFs powder was recorded on Stoe STADI-P spectrometer at ambient temperature, with tube voltage of 40 kV, tube current of 40 mA in a stepwise scan mode (5° min⁻¹). FTIR spectra was recorded with Perkin Elmer Spectrum Two™ spectrophotometer in the region of 600 to 4000 cm⁻¹. Transmission electron microscopy (TEM) micrographs were collected using a JEOL JEM2100 microscope at a beam acceleration field of 200 kV. Ellipsometry data was collected using Semilab SE 2000 at room temperature using a wavelength range of 240 nm-2000 nm. The data was modelled using Tauc-Lorentz equation in SEMILAB software.

### Example 1—APTES Functionalization of Glass Substrate

Glass microscope slides were immersed into 1% n-hexane solution of APTES in a petri dish and incubated for 2 h at room temperature. The slide was thoroughly rinsed with n-hexane to remove the physisorbed APTES molecules and then dried under N₂.

### Example 2—Layer-by-Layer Growth of MOFs

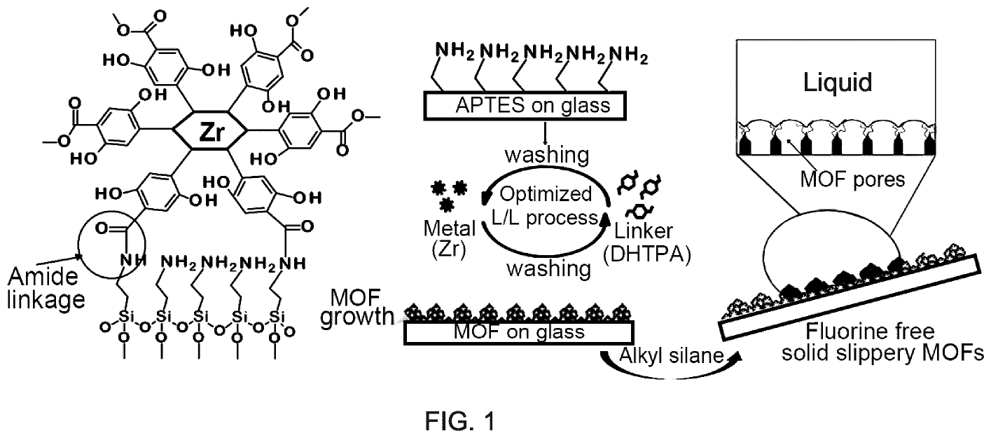

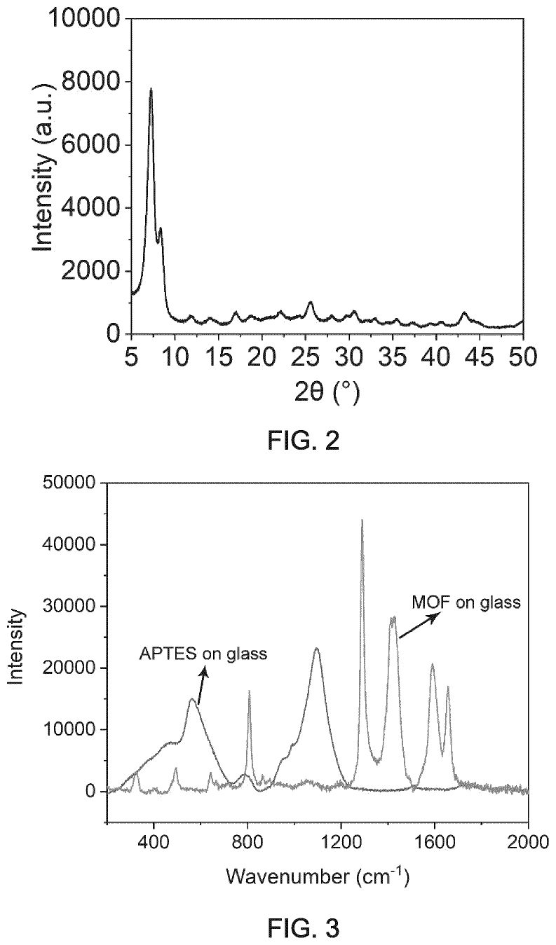

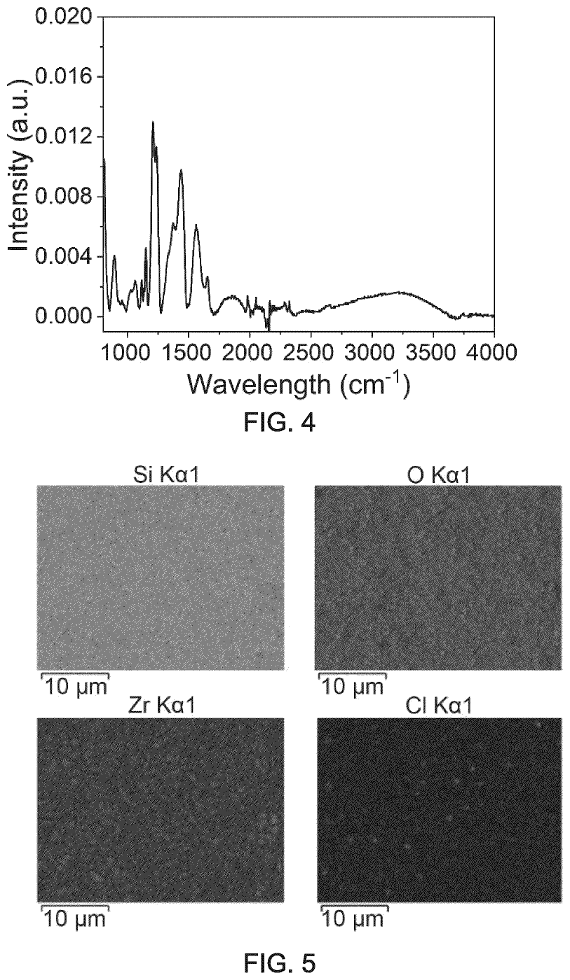

The synthesis parameters including number and time for each repeated cycle, reagents concentration and washing step were optimized for layer-by-layer (L/L) growth of Zr-MOFs (see also Example 3). In a typical optimal cycle of L/L growth of MOF, glass slides pre-functionalized with APTES (Example 1) were immersed into 100 mL of DMF solution of DHTPA (25 mM) in a tightly closed glass bottle for 4 hrs to get uniform self-assembly of DHTPA onto the substrate at 120° C. The substrate was then rinsed in DMF and immersed in 25 mM DMF solution of ZrCl₂·8H₂O for 20 minutes at 120° C. followed by washing (which included 1-minute sonication) and immersion into DHTPA solution for another 20 minutes. This completed one cycle of MOF growth, see FIG. 1 for a representation of the L/L growth process. Various number of cycles were repeated to optimize and achieve the controlled growth of the MOF films. Finally, the surface was thoroughly washed by sonicating in DMF to remove metal or linker aggregates. The MOF on glass was then treated in chloroform for 48 hrs to activate the pores (to remove the traces of DMF and any other solvents) and then vacuum dried overnight at 100° C. After synthesis, the MOF film was characterized to determine crystallinity using PXRD (FIG. 2), chemical structure by Raman (FIG. 3) and FTIR (FIG. 4). The sharp peaks at 1435 cm⁻¹ and 1563 cm⁻¹ of FIG. 4 are ascribed to the in- and out-of-phase stretching modes of the carboxylate group presented in the linker. The broad peak for hydroxyl groups is observed at 3200-3500 cm⁻¹. Elemental distribution of Si, O, Zr and Cl was measured with EDS mapping was performed (FIG. 5). Si, O and Zr were found to be abundantly spready across the surface, while barely any Cl was observed.

### Example 3—Synthesis Optimisation of MOF Film

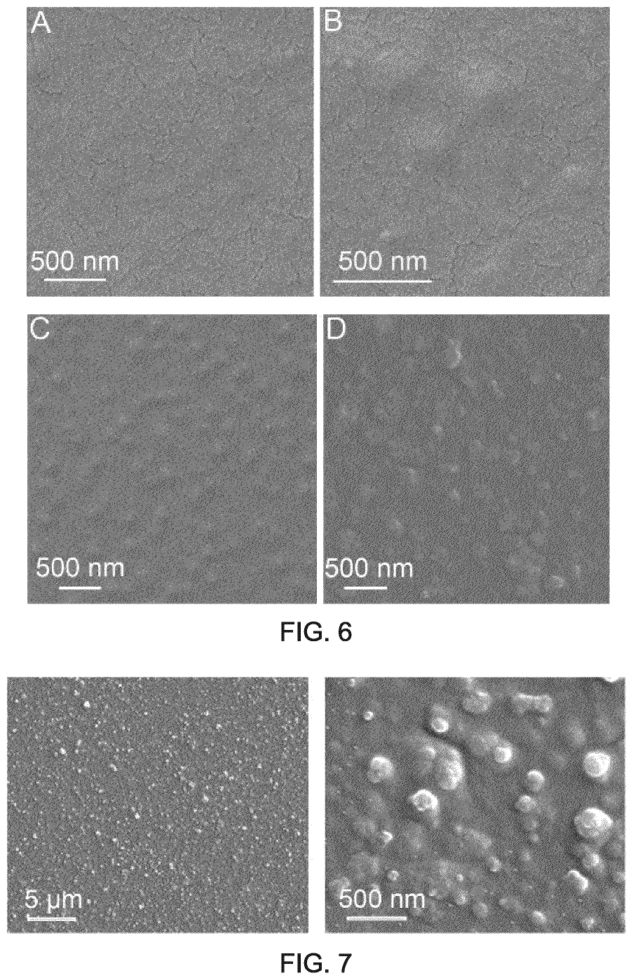

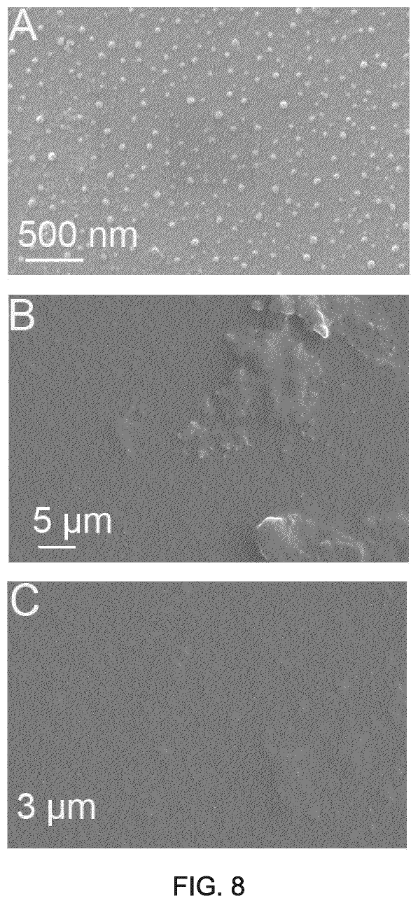

The film growth during L/L growth (see Example 2) was tracked using SEM imaging to check the change in the morphology after each layer as shown in FIG. 6. After first layer, the growth is even with numerous cracks (A). After the second layer the cracks started to disappear, and MOF particles start to grow as bulges (B). The cracks completely disappeared after 4 layers with several MOF particles clearly emerging (C) which turned into rough particles after 5th layer (D). For the concentration of organic linker and metal, 25 mM was found to be the optimum and yielded a uniform MOF film with controlled roughness (FIG. 7). The growth of MOF film was recorded to be very slow at lower concentration (5 and 10 mM) of reagents (FIG. 8A) and resulted in nanometre sized but uniformly distributed particles. However, the obtained roughness was very low even after 10-15 repeated cycles. Conversely, with 50 mM concentration, the growth of larger MOF clusters were observed (FIG. 8B) even after the 3rd layer unlike the optimized film where a uniform film was formed first and then the particles started emerging afterwards (FIG. 6D). The washing procedure in between the growth cycles was recorded to be very important in maintaining transparency as it was necessary to remove the metal aggregates and physically adsorbed linkers. In addition to the simple rinsing, we introduced the 60 s sonication after each cycle to ensure the removal of unreacted reagents.

Under optimised growth conditions for Zr(UiO-66-OH) [Example 3], after 2-3 layers, the films remained smooth and uniform. Beyond the third layer, roughness started increasing. The surface roughness increases with the number of layers and thus, the hysteresis started increasing after 6 layers, without wishing to be bound by theory the increase in hysteresis is possibly due to the adverse effect of roughness on slippery behaviour. Beyond an upper limit of roughness, typically reached at number of layers greater than about 9, possibly greater than about 6 in some cases, the solid liquid contact raises the liquid adhesion to the films.

Transmittance is relatively unaffected for six or fewer layers of Zr(UiO-66-OH) grown under optimised conditions (Example 3). After 6 layers, transmittance of visible light begins to decrease from >93% to ˜90%. Further layers results in a successive decrease in transmittance. This stepwise decrease in transmittance can be observed with the naked eye.

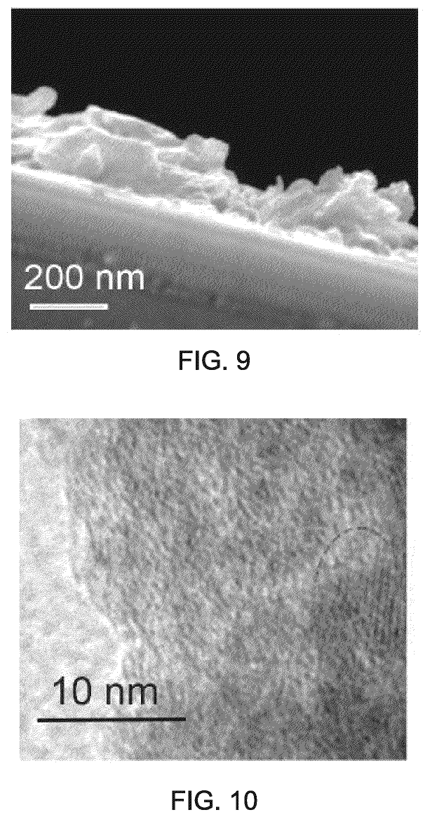

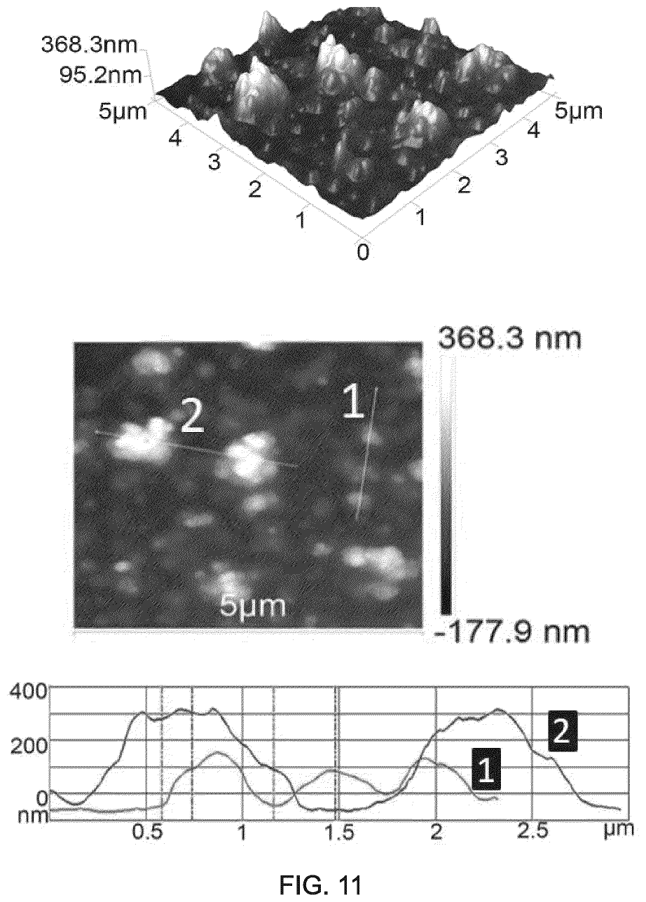

For the optimised film conditions (25 nM and 6 repeated cycles) the cross-section of the MOF on glass as determined by SEM (FIG. 9), confirms the nanoroughness and a film thickness of ˜200 nm, in agreement with ellipsometry which yielded thickness and refractive index of 165 nm and ˜1.5, respectively. Transmission electron microscope (TEM) imaging revealed the microporous structure of MOF film at high magnification (FIG. 10). 3D topology of the 6-layer nanohierarchical MOF was imaged using an atomic force microscope (AFM) (FIG. 11); the route mean square roughness was ˜73.9 nm and the maximal height of MOF clusters ranged from ˜100 nm to ˜300 nm.

### Comparative Example 1—Effect of APTES Functionalisation

Layer-by-layer growth of MOF was carried out as detailed in Example 2 except the glass-slide was not pre-functionalized with APTES; the growth of MOF without APTES was very slow and resulted in non-uniform MOF bulges as shown in FIG. 8C. Whereas, APTES functionalized glass produced uniform and controlled MOF film as shown in FIG. 7 (see Example 3).

### Example 4—Post-Synthesis Functionalisation of MOFs

Alkyl silanes were used to convert the as-synthesized hydrophilic MOF film into hydrophobic structures. Liquid immersion method was adopted as used for APTES functionalization (see Example 1). The glass substrate with MOF film (of Example 2) was immersed into 1% solution of silanes in n-hexane (trichlorohexyl silane, trichlorododecyl silane, trichlorooctadecyl silane) for 2 hrs and placed at 120° C. for another 2 hrs then rinsed with n-hexane. The hydrophobic substrate was then dried under N₂ stream and stored for further characterisation.

Alkyl silanes reacted with the hydroxyl group of the dihydroxyterepthalic acid linker to give a post-synthetic alkyl silane functionalised linker according to the following formula, for example when trichlorooctadecyl silane is used:

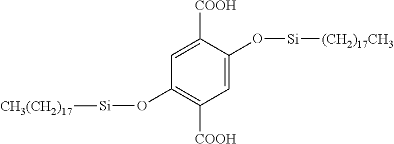

### Example 5—Transparency and Measurement

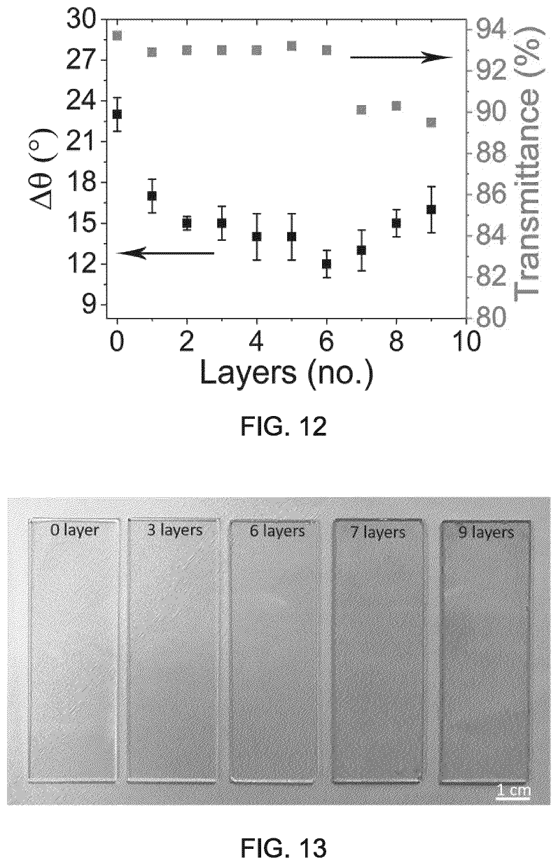

Transparency of the MOF coated glass surface of Example 4 was tuned by controlling the thickness/number of MOFs layers. As shown in Table 1, no change in the transmittance was recorded up to 6 layers of MOFs (FIG. 12). However, the transmittance decreased to ˜90% from >93% when the number of layers exceeded six. The successive change in the transmittance with increase in number of MOF layers was also visible to the naked eye (FIG. 13). The scattering behaviour of the films was measured in transmission using a Radiant Zemax Imaging Sphere for Scatter and Appearance Measurement. The samples were illuminated at a normal angle of incidence at 50 nm wavelength intervals between 400 and 700 nm wavelengths. To get the single transmittance value at photopic response, the photopic response function was calculated using MATLAB.

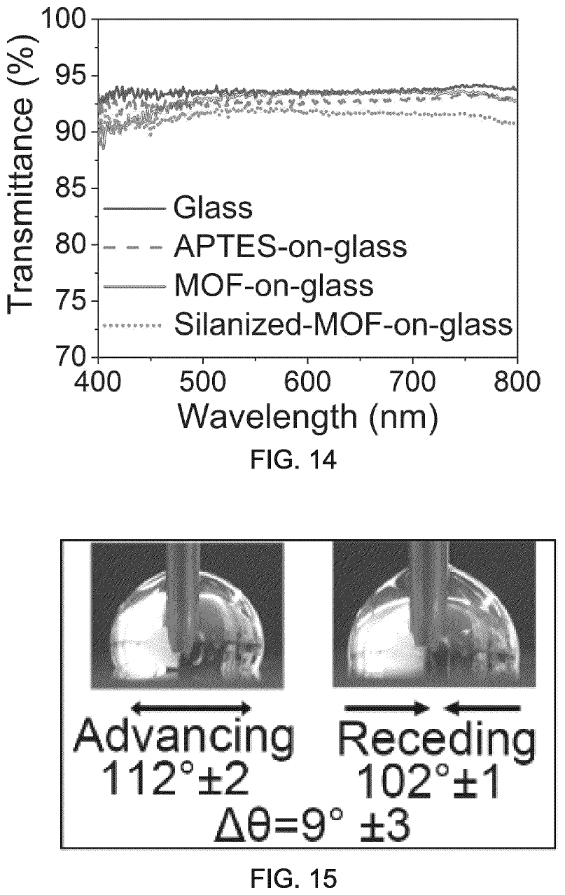

Comparison of transmittance between naked glass, glass functionalised with APTES (Example 1), glass with the MOF (Example 3) and Glass with the post-synthetically modified (silanized) MOF (Example 4) revealed that all have excellent transmittance (>92%) across the visible spectrum (FIG. 14).

TABLE 1
Changes in transmittance and hysteresis for
different number of MOF film growth cycles

| Layer number | Hysteresis (°) | Transmittance |
|---|---|---|
| 0 | 23 | 93.7 |
| 1 | 17 | 92.9 |
| 2 | 15 | 93.0 |
| 3 | 15 | 93.0 |
| 4 | 14 | 93.0 |
| 5 | 14 | 93.2 |
| 6 | 12 | 93.0 |
| 7 | 13 | 90.1 |
| 8 | 15 | 90.3 |
| 9 | 16 | 89.5 |

### Comparative Example 2—Fabrication of Liquid Infused MOFs (SLIPS)

The MOF SLIPS were prepared using a simple procedure by replacing silane, of Example 4, with silicone oil (500 cSt). SLIPS surfaces are now well established for low hysteresis and droplet sliding despite lower overall contact angles compared to superamphiphobic surfaces (with θ_{A}>150°). The MOF coated glass slide was placed horizontally and infused with 2 mL silicone oil for 24 hrs and tilted to 90° for 2 hrs to remove excess oil.

### Comparative Example 3—Fabrication of Slippery Omniphobic (SOCAL) Coating

A SOCAL surface was prepared to compare for ice adhesion strength with the nanohierarchical MOF surface as defined herein. The fabrication process was adopted from previously published work (Wang et al., 2016). In brief, a mixture of isopropanol (50 g), dimethyldimethoxysilane (5 g) and sulfuric acid (1 g) was prepared in a clean glass bottle. The solution was sonicated for 120 seconds and stored at room temperature for further use. An oxygen plasma cleaned glass slide was submerged in the solution for 5-10 seconds and withdrawn gradually. The excess liquid was drained from the surface. The substrate was dried at room temperature (>60-70% relative humidity) for 1 hr. Then the surface was rinsed with hexane, toluene and isopropanol and dried under N₂.

### Comparative Example 4—Fabrication of Trichlorooctadecyl Silane (OTS) Coating

An OTS coating was prepared by liquid immersion method. In brief, a glass slide was immersed into 1% of n-hexane solution of OTS in a petri dish and incubated for 2 h at room temperature. The slide was thoroughly rinsed with n-hexane to remove the physiosorbed silane molecules and then dried under N₂.

### Example 6—Wettability Tests

A custom goniometer setup was used for contact angles measurements (Peng et al., 2018). The setup consists of an adjustable stage, retort stand and syringe pump (World Precision Instruments, Aladdin single-syringe infusion pump), a light source (Thorlabs, OSL2) and a zoom lens (Thorlabs, MVL7000) fitted to a CMOS camera. To measure the contact angles and the contact angle hysteresis, the videos of the droplet were analysed with MATLAB.

Surface wettability of the MOF coated glass surface of Example 4 was tuned by controlling the thickness/number of MOFs layers, this was evaluated by measuring advancing (θ_{A}) and receding (θ_{R}) contact angles of water droplets and the hysteresis (Δθ), calculated using (Δθ=θ_{A}−θ_{R}). The surface roughness is increased with the number of layers and thus, the hysteresis (Δθ) started increasing after 6 layers (Table 1), possibly due to the adverse effect of roughness on slippery behaviour. This is understandable given the fact that beyond a critical roughness, the solid liquid contact will raise the liquid adhesion to the films.

Measurement of advancing and receding contact angles for water on the MOF coated substrate in shown in FIG. 15.

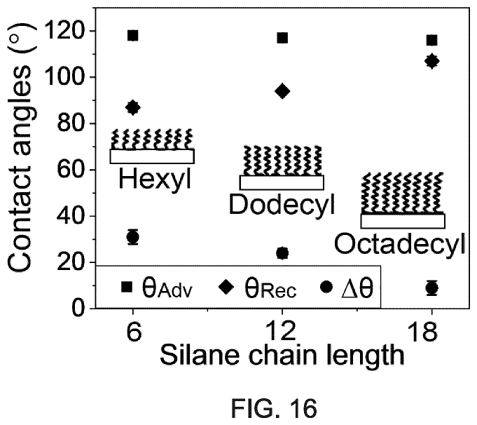

Sliding behaviour was also investigated for surfaces functionalised with trichlorohexylsilane (C₆, ˜0.924 nm), trichlorododecyl silane (C₁₂, ˜1.84 nm) and trichlorooctadecyl silane (C₁₈, ˜2.77 nm). Table 2 shows that OA remained approximately constant and OR increased with carbon chain length of the silanes, yielding a hysteresis of 9°±2° for the octadodecyl silane (also shown in FIG. 16).

TABLE 2
Contact angle measurements for different length
alkyl surface functionalisation groups.

| Silane | Advancing angle | Receding angle | Hysteresis |
|---|---|---|---|
| Trichlorohexyl silane | 118.0 | 87 | 31.0 |
| Trichlorododecyl silane | 117.3 | 94 | 23.3 |
| Trichlorooctadecyl silane | 115.7 | 107 | 9.3 |

The contribution of low solid fraction could be clearly appreciated from the enhancement in advancing angle of water droplet from ˜102° on the glass substrate modified with same silane (Comparative Example 4) to ˜112° on the hydrophobic MOF film (Example 4).

The solid fraction, ϕ, of MOF was estimated, by considering the geometry of the MOF pores and the corresponding unit cell, to be

$$ϕ = 1 - \frac{{S}_{hole}}{{S}_{cell}} = 1 - \frac{π {R}^{2}}{3 \sqrt{3} {R}^{2}} = 0.4$$

where S_{cell} and Sₕₒₗₑ denote the surface area of the unit cell and the hole inside cell, respectively. R is the radius of the hole (approximated to be a spherical). The reported geometrical details and molecular dimensions (pore diameter˜6 Å) from literature were used.

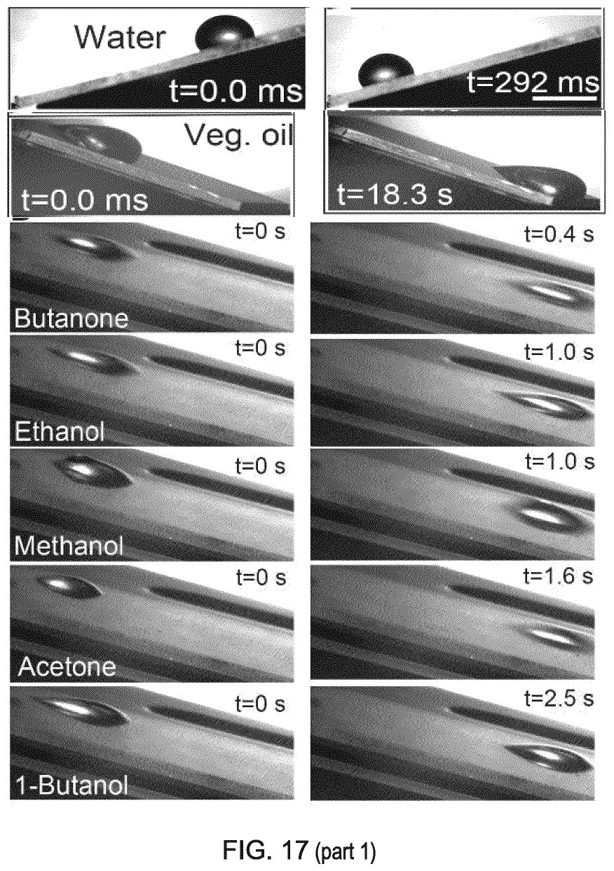

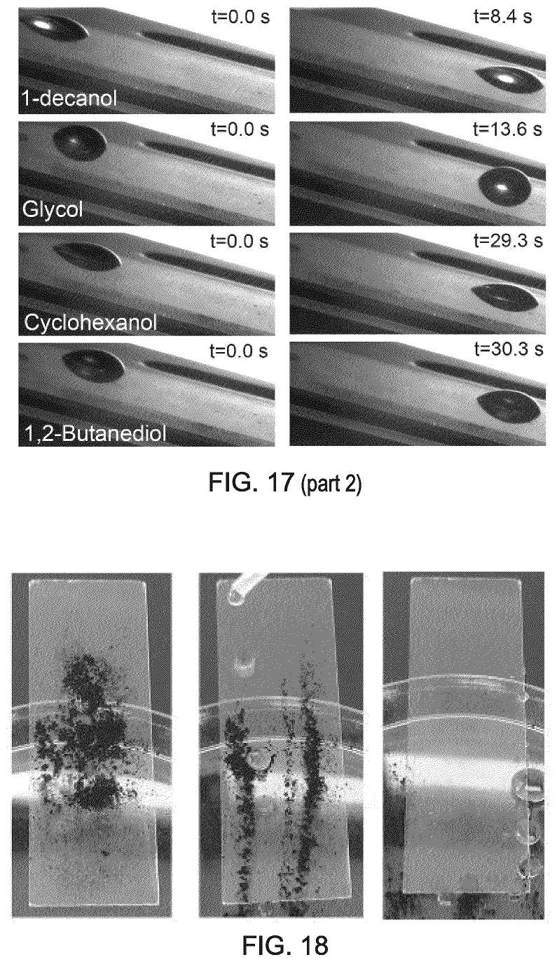

Free sliding of vegetable oil was observed at 15°, and the surface also showed repellency to alcohols or polar liquids. Butanone (23.9 mN/m), ethanol (22.1 mN/m), methanol (22.5 mN/m), acetone (25.2 mN/m), 1-butanol (25 mN/m), 1-decanol (28.5 mN/m), glycol (47. mN/m), cyclohexanol (33.4 mN/m) and 1,2-butanediol (37.2 mN/m) were also tested and slid off at 15° inclination (FIG. 17). Carbon powder was easily removed by water drops sliding off the surface, confirming the self-cleaning property (FIG. 18)

### Example 7—Drop Mobility Tests

Drop mobility test was carried by releasing water droplets of various volumes (5, 10, 15, 20, 25, 30, 35, and 40 μL) on the MOF on glass surface lying on a 30° tilted stage. The average speed was obtained by recording twice using high-speed camera (Phantom V411). The same process was followed for MOF SLIPS and for thermal stability tests (see Example 13) where the droplet of 20 μL was used after heating the surface at specific temperature for 1 hr.

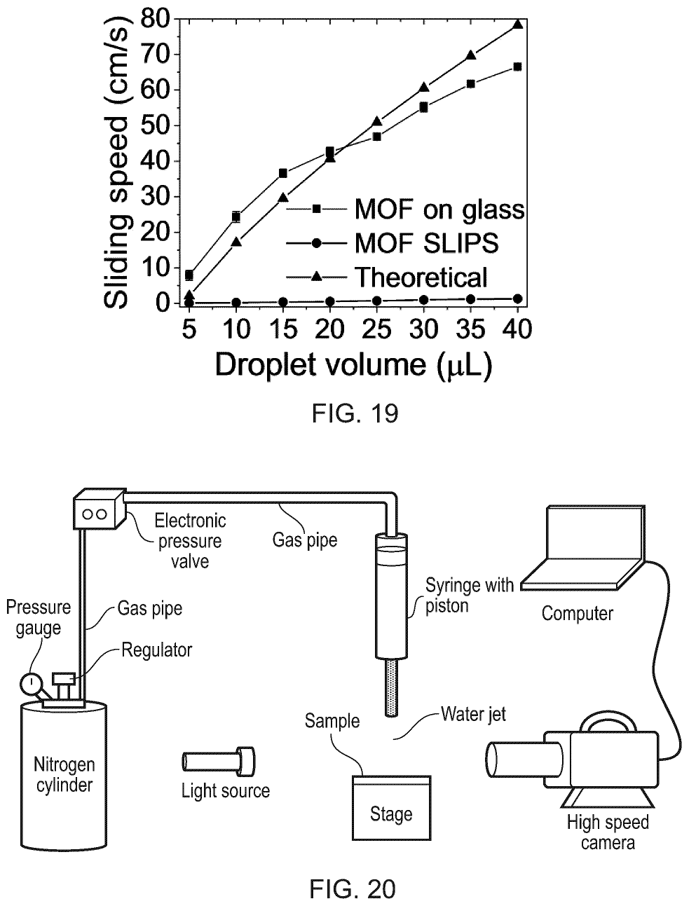

A linear increase in the sliding speed from 7.9±1 cm/s to 66.6±1 cm/s was observed with change in droplet volume from 5 μL and 40 μL (FIG. 19). The droplet sliding speed on the SLIPS surface of comparative example 2, was 10-fold lower, underscoring the excellent liquid mobility of the nanohierarchical MOF surfaces as described herein (Table 3, FIG. 19).

TABLE 3
Comparison of droplet sliding speeds.

| | |
|---|---|
| Droplet | Droplet sliding speed (cm/s) |

| volume | Example 4 | Comparative Example 2 |
|---|---|---|
| (μL) | (MOF surface) | (SLIPS surface) |
| 5 | 7.9 | 0.07 |
| 10 | 24.3 | 0.20 |
| 15 | 36.6 | 0.37 |
| 20 | 42.6 | 0.52 |
| 25 | 46.9 | 0.71 |
| 30 | 55.2 | 0.98 |
| 35 | 61.7 | 1.17 |
| 40 | 66.6 | 1.29 |

### Example 8—High-Speed Jet Impact

To overcome the limitation of low terminal speed of free-falling droplets, a setup was used to obtain a continuous and controlled water jet (FIG. 20). A high-pressure nitrogen gas cylinder connected to an electronic pressure valve was used to force water through a nozzle (a needle/syringe assembly). The water jet diameter was 0.5 mm and 2.5 mm. Due to system transients, upon application of pressure control signal on the electronic control valve, the gas back pressure on the piston in the syringe will ramp up to the maximum ˜13 bar over a finite time period. This transient process should lead to a time dependent rise in jet speed before levelling off to a steady value corresponding to the maximum applied pressure. To unravel this transience, we recorded the motion of the piston/water interface inside the syringe during typical jet impact process using the high-speed camera. The motion of the piston could be used to determine the jet speeds through simple mass conservation and knowledge of the cylinder and the nozzle diameters. Thus, after reaching steady speed, if in time Δt the piston in the syringe moves by a distance Δh, we can write πdₛ²Δh/4=πdₙ²VΔt/4, where dₛ is the cylinder diameter, dₙ the nozzle (jet) diameter and V the jet speed. The maximum jet speed reached in the present experiments (35.1 m/s) was determined by averaging the maximum speeds in different tests. The corresponding liquid Weber number

$$( {We}_{l} = \frac{ρ {V}^{2} {d}_{n}}{γ} )$$

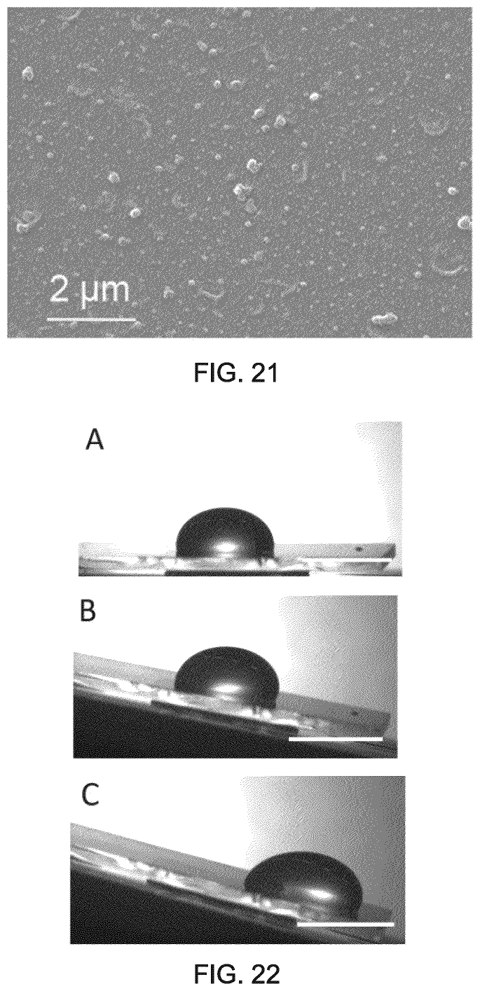

for the 0.5 mm and 2.5 mm jet are ˜8,500 and ˜42,500. The surface of Example 4 showed no signs of liquid impalement even after repeated jet at least 3 times on same spot (FIG. 21). The lack of liquid impalement was assessed using droplet mobility test. This comprised of positioning the surfaces horizontally and placing a droplet at the centre of impact location. Then the surface was tilted gently to ensure that the droplet slid off, confirming a lack of liquid impalement during jet impact no pinning of droplets was observed on tilting and amphiphobic slippery behaviour was maintained (FIG. 22).

### Example 9—Hydrophobicity Retention Test

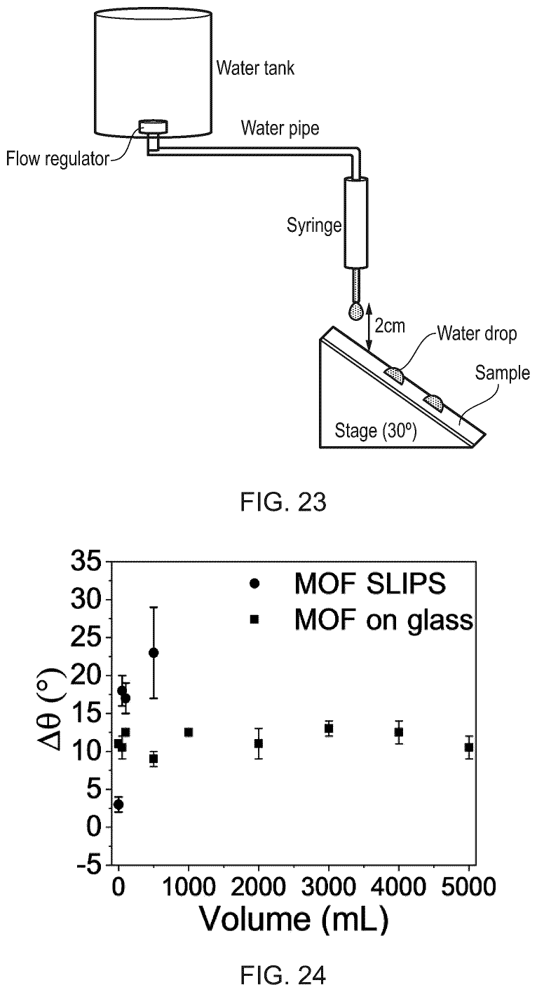

Slippery behaviour and hydrophobicity (liquid repellence) of the SLIPS surfaces are known to be susceptible to gradual drainage of the lubricant film under shear flow or sustained sliding of droplets on them. The surfaces of the present invention, lacking any oil infusion, are expected be immune to this. For this test, a bespoke setup comprising a water tank (plastic, 2-L water bag) connected to syringe via flow controller was used (FIG. 23). A continuous flow of water droplets (at the rate of 1 L/h from 2 cm height) was dripped onto test surface placed on a 30° titled stage. This created a continuous stream of drops sliding off the surfaces under test. Contact angle measurements were taken (according to Example 6) after drainage of 50 mL, 100 mL, 500 mL, 1,000 mL, 2,000 mL, 3,000 mL, 4,000 mL, and 5,000 mL of water from the bag.

The nanohierarchical MOF surface of Example 4 showed excellent stability with no change in hysteresis whereas a rapid increase in hysteresis from ˜4° to ˜23° was observed on the SLIPS surface of Comparative Example 2 due to oil depletion (Table 4, FIG. 24).

TABLE 4
Comparison of hydrophobicity retention

Hysteresis (Δθ)

| Volume | Example 4 | Comparative Example 2 |
|---|---|---|
| (mL) | (MOF surface) | (SLIPS surface) |
| 50 | 11.0 | 3 |
| 100 | 10.5 | 18 |
| 500 | 12.5 | 17 |
| 1000 | 9.0 | 23 |
| 2000 | 12.5 | N/A |
| 3000 | 11.0 | N/A |
| 4000 | 13.0 | N/A |
| 5000 | 12.5 | N/A |

### Example 10—Mechanical Stability

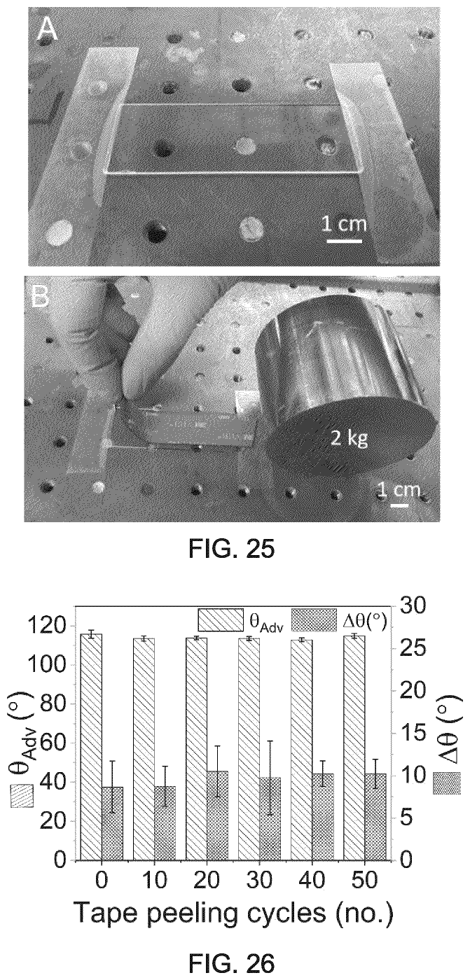

To evaluate the mechanical durability of the coatings, a pressure-sensitive and strong adhesive tape (3M VHB™ tape 5952 with adhesive peel strength of 3,900 N/m) was used. The tape was applied on horizontally placed hydrophobic MOF surface by rolling 2-kg steel roller on the tape and then the tape was removed after waiting for 60 s as shown in FIG. 25. This whole process was considered as one cycle; the contact angle measurements were performed after each cycle. The process was repeated, and a fresh piece of tape was used in each cycle.

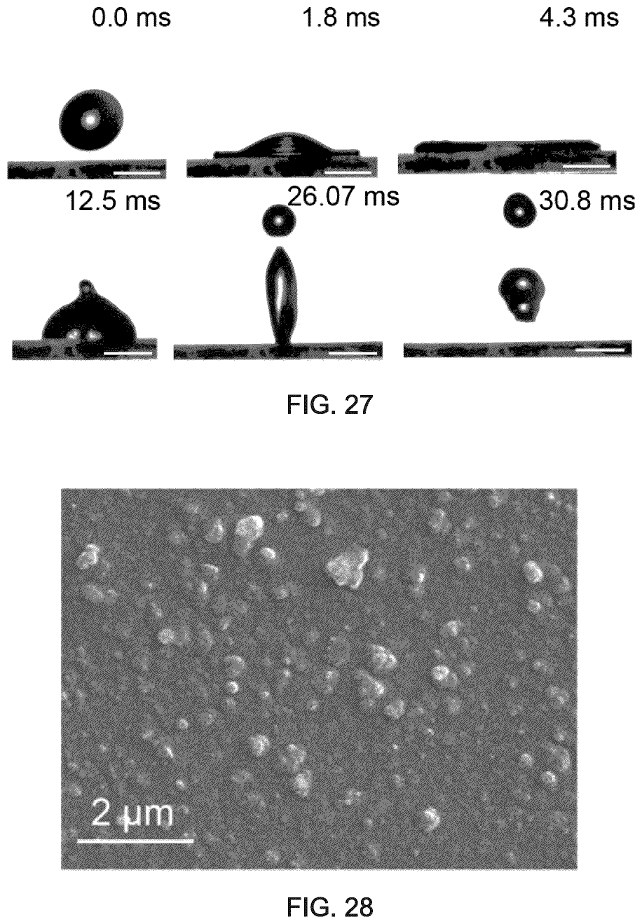

No significant change in the contact angles and hysteresis (tested according to Example 6) was observed even after 50 repetitive cycles (FIG. 26, Table 5). Following tape-peel, drop impact test (1.2 m/s) on the surface showed bouncing of water droplets after 50 repetitive tape peel cycles (FIG. 27) and morphological characterization with SEM confirmed that the structure of the surface appeared to be unchanged (FIG. 28) to confirm robustness.

TABLE 5
Mechanical stability of MOF film

| Number of | Average | Average | Average |
|---|---|---|---|
| tape peel | advancing | receding | hysteresis |
| cycles | angle (°) | angle (°) | (°) |
| 0 | 115.7 | 107.0 | 8.7 |
| 10 | 113.5 | 104.8 | 8.8 |
| 20 | 113.8 | 103.3 | 10.5 |
| 30 | 113.5 | 103.8 | 9.8 |
| 40 | 112.8 | 102.5 | 10.3 |
| 50 | 114.8 | 104.5 | 10.3 |

### Example 11—Pencil Hardness Test

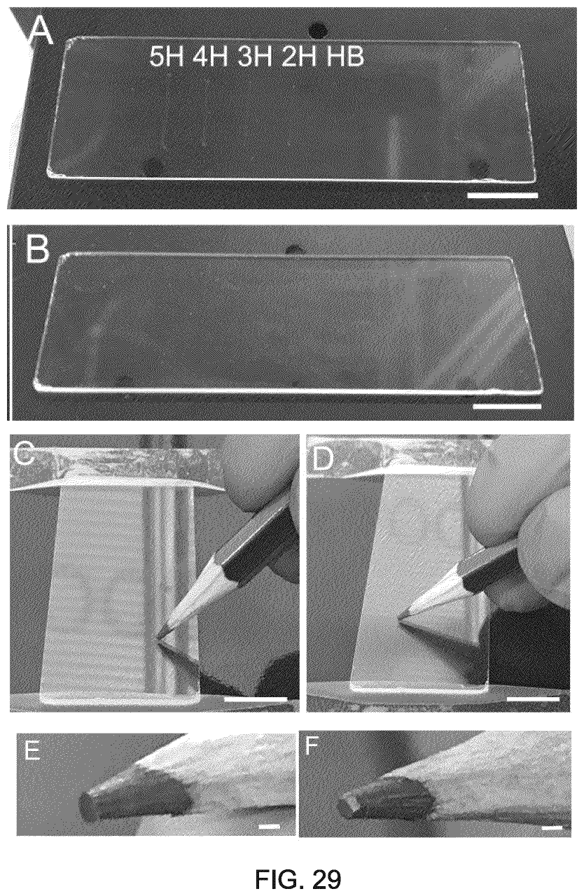

The resistance of MOF films to scratches and wear was tested via standard pencil hardness test (ASTM D 3363). Pencils with five different hardness level, HB, 2H, 3H, 4H and 5H were used in the test. The pencil marks could be clearly observed on surface (FIG. 29A) just after the test. However, the scratches completely disappeared after gentle cleaning with the tissue paper (FIG. 29B), suggesting that there was no permanent damage into the MOF films, rather the marks were left by pencil lead erosion. For these tests, pencil leads with flat cross-section were achieved (FIG. 29E) by rubbing the pencils on sand paper. The flat pencil leads were pushed at ˜45° angle against a horizontally laid MOF surface according to Example 4 (FIGS. 29 C and D). After the test, integrity of the surface was checked by measuring the contact angles (according to Example 6) and drop mobility (according to Example 7) on the scratched areas. The advancing (113°±2), receding (102°±2) and hysteresis (10°±1) angles all remained unchanged. No pinning was observed in drop mobility test, confirming the surface integrity and excellent resistance against mechanical scratches.

### Example 12—Chemical Stability

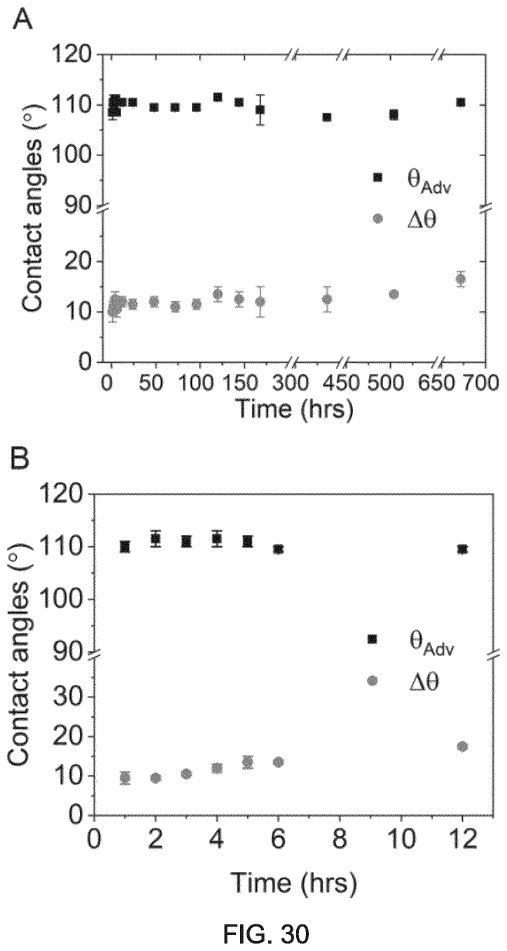

The chemical stability test was performed in acidic (pH, 1-2) and basic (pH, 11-12) solutions. The test surfaces were immersed for specific time periods, rinsed in DI water and dried followed by contact angle measurements (according to Example 6). Stability ranged from several hours (>12 h) in base, to a month (700 h) in acid as measured by a lack of change in contact angles measured at given time points FIG. 30.

### Example 13—Thermal Stability

To evaluate the thermal stability of the MOF surface, the substrate was placed on a temperature-controlled hotplate at specific temperatures from 40° C. to 200° ° C. for 1 hr. The surface was brought to the room temperature and contact angles measurements and drop mobility tests were performed to determine the change in hysteresis angle and sliding speed.

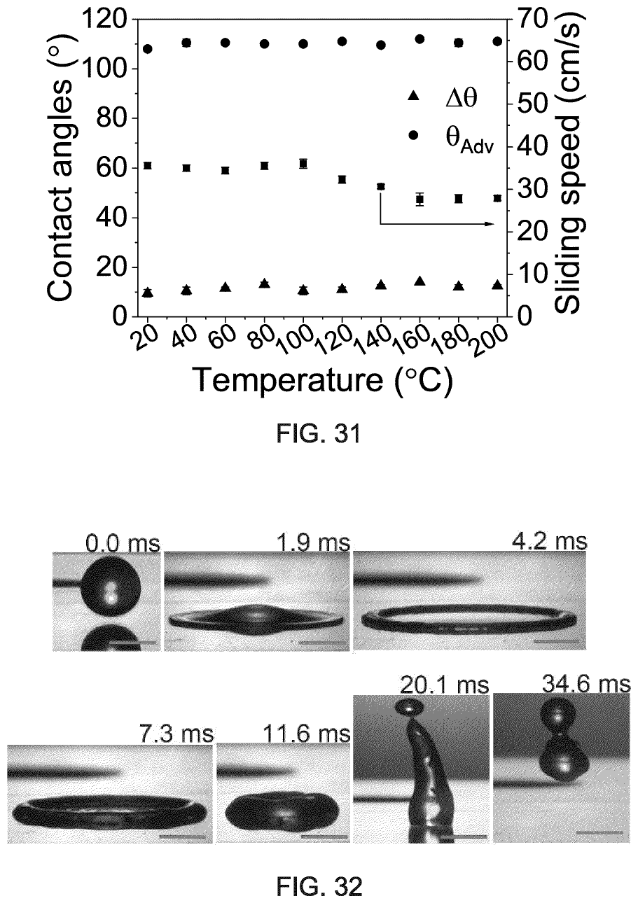

The slippery MOF surface (according to Example 4) demonstrated good thermal stability up to 200° C. (FIG. 31, Table 6). The sample was heated for 60 minutes at each temperature, followed by cooling to room temperature and measurement of the wetting angles and the sliding speed (according to Example 6). The surface maintained the hydrophobicity and suffered an only slight decline in the sliding speed from ˜35 cm/s to ˜30 cm/s.

TABLE 6
Drop mobility after heat treatment.

| | Sliding | Advancing | |
|---|---|---|---|
| Temperature | speed | contact | Hysteresis |
| (° C.) | (cm/s) | angle (°) | (°) |
| 20 | 35.6 | 108.0 | 9.5 |
| 40 | 35.0 | 110.5 | 10.5 |
| 60 | 34.4 | 110.5 | 11.5 |
| 80 | 35.6 | 110.0 | 13.0 |
| 100 | 36.0 | 110.0 | 10.5 |
| 120 | 32.3 | 111.0 | 11.0 |
| 140 | 30.6 | 109.5 | 12.5 |
| 160 | 27.7 | 112.0 | 14.0 |
| 180 | 27.8 | 110.5 | 12.0 |
| 200 | 27.9 | 111.0 | 12.5 |

### Example 14—Droplet Impact Resistance

For the droplet impact test, a high-speed camera (Phantom V411) was used to record at a rate of 10,000 frames per second. ˜2.7 mm size deionized water droplets were released from various heights with the help of syringe pump (world precision instrument) connected to a syringe/needle assembly.

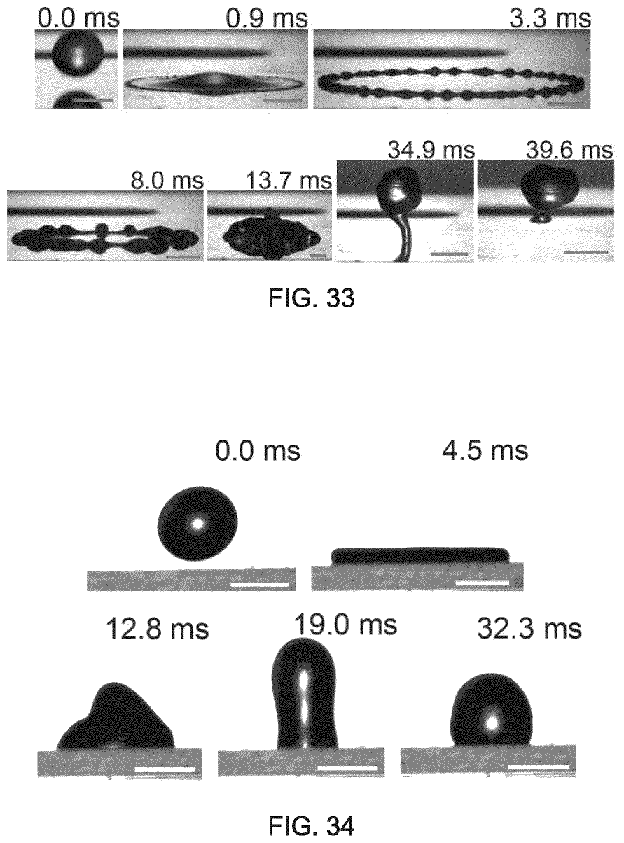

Drop impacts at 1.4 m/s, and 4.2 m/s (drop diameter=˜2.7 mm), with relatively low and high contribution of impact kinetic energy, were used to investigate low-speed liquid impacts. The stages in impact dynamics are shown in FIGS. 32 and 33. The droplets bounced off the MOF surface (according to Example 4) and roughly took the same time irrespective of the impact velocity. However, the impact velocities of 1.4 m/s and 4.2 m/s led to spreading diameters of ˜1.0 cm and ˜1.5 cm, respectively, and hydrodynamic instability in rim was observed for impact velocity of 4.2 m/s. Silanized bare glass surface (according to Comparative Example 4) showed no bounce off (FIG. 34).

### Example 15—Ice Adhesion

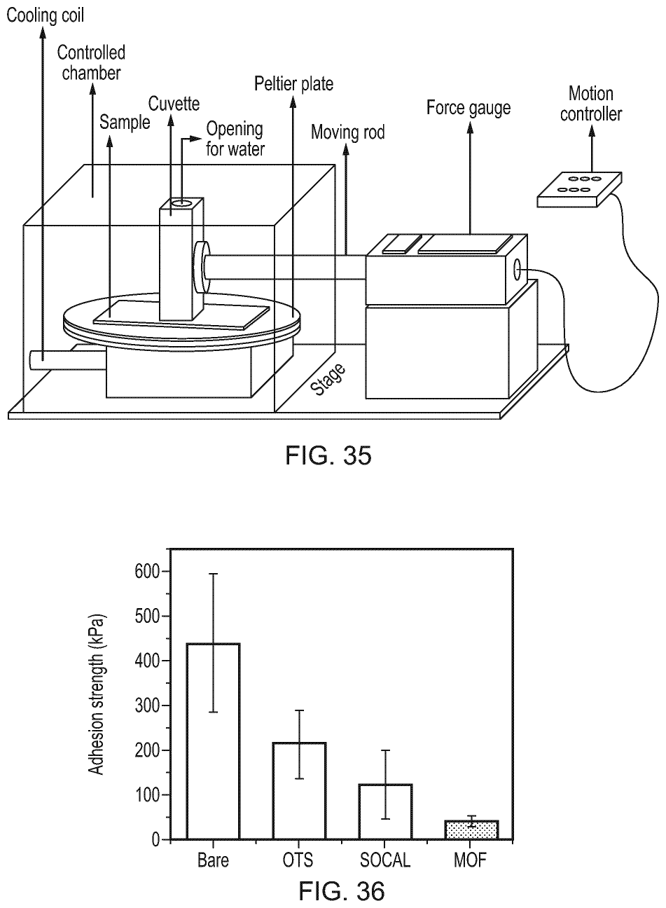

A custom designed bench-top icing chamber was used for ice adhesion experiments. The chamber comprised of a transparent, double-wall container and a cooling base (FIG. 35). The chamber has an external dimension of (30 cm×20 cm×18 cm) and a 10 mm air gap between its external and internal walls. Both walls are 5 mm thick and made of thermally insulating acrylic (Perspex) with a low thermal conductivity of 0.2 (mK)⁻¹. This air gap was evacuated to improve the insulation. Holes on walls were designed for introducing water into the measurement cuvettes and fitting in the metal rod used to deflect the cuvettes (see FIG. 35). As for the base, it consists of an aluminium frame, a base plate, a compact heat exchanger (P1805368, UK Exchangers), 4 axial fans below the heat exchanger (ARX CeraDyna Series, RS Components), a rotary aluminium stage, a plastic shaft and two Peltier cooling modules between the aluminium stage and the heat exchanger. The chamber temperature was measured using 4 K-type thermocouples (HH506RA) and controlled using a refrigeration unit (FP50-HL Refrigerated/Heating Circulator, Julabo) with bath fluids (H5, Julabo) connected to the compact heat exchanger. The chamber humidity was measured by a 3-pin humidity sensor (HIH-4000-001, RS Components). The data acquisition system (DAQ) included a compact DAQ chassis (cDAQ-9174, National Instruments) with a temperature module (NI9213), a voltage module (NI-9263) and an analogue module (NI-9209) (75). During experiments, all openings/holes were blocked by putty-like adhesives (Blu Tack). For ice adhesion measurement, an extension rod connected to a force gauge (M4-50, MARK-10) were mounted on a custom-made driving system with a stepper motor (17HS19-2004S1). This enabled deflecting the cuvettes with frozen liquid laterally and measuring the required forces. The extension rod is 127 mm long, and its flattened end has a diameter of 25 mm. LABVIEW software was used to operate and record the forces and determine the corresponding adhesion strength.

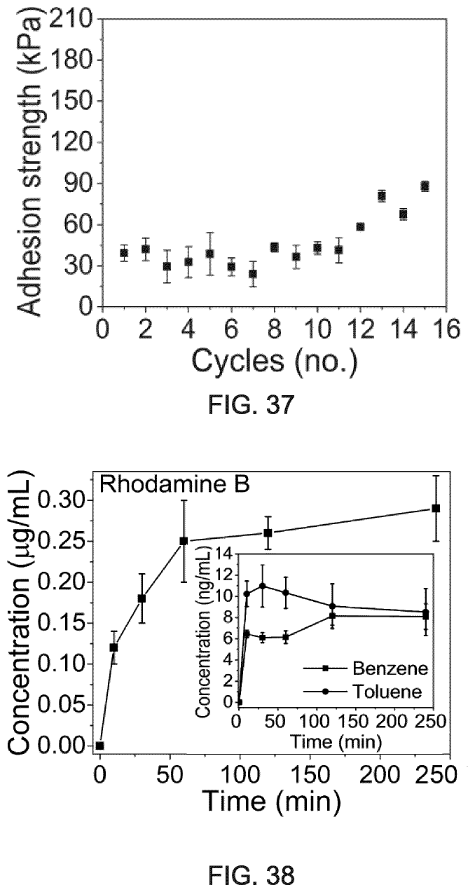

Bare glass and glass functionalized with same silane used to functionalize MOF (Comparative Example 4) were uses as references. Additionally, ultra-smooth polydimethylsiloxane oligomers (SOCAL) treated glass⁴ (Comparative Example 3) was also used. Lowest ice adhesion strength of 35±10 kPa was recorded on the nanohierarchical MOF surface (according to Example 4) (FIG. 36, Table 7). The surface robustness was tested by repeating icing/de-icing cycles; no change in the ice adhesion strength was observed up to 11 cycles (FIG. 37, Table 8).

TABLE 7
Comparison of ice adhesion strength values

| Substrate | Ice adhesion (kPa) |
|---|---|
| Bare glass | 439.9 |
| Comparative Example 4 | 213.5 |
| Comparative Example 3 | 122.7 |
| Example 4 | 40.6 |

TABLE 8
Durability of MOF surface to repeated icing cycles.

| Number of icing cycles | Ice adhesion (kPa) |
|---|---|
| 1 | 39.3 |
| 2 | 42.0 |
| 3 | 29.5 |
| 4 | 32.7 |
| 5 | 38.7 |
| 6 | 29.2 |
| 7 | 24.0 |
| 8 | 43.5 |
| 9 | 36.5 |
| 10 | 43.0 |
| 11 | 41.3 |
| 12 | 58.2 |

### Example 16—Pollutant Adsorption

Adsorption of rhodamine B was quantified using UV-vis spectroscopy (Shimadzu, UV2600i) by measuring the absorbance at 553 nm. A stock solution of 1 mg/mL was prepared by dissolving rhodamine B in water. The stock solution was, then, diluted (0.62 μg/mL, 1.25 μg/mL, 2.5 μg/mL, 5 μg/mL and 10 μg/mL) to acquire a calibration curve. For adsorption study, a MOF coated glass slide was dipped in a 50 mL solution of 10 μg/mL rhodamine B. The solution was subjected to absorbance measurement at predetermined intervals of 10 min, 30 min, 1 hr, 2 hrs and 4 hrs by taking 2 mL each time from the solution at 25° C.

The measurements of benzene and toluene were performed using a Thermo Scientific Trace 1300 Gas Chromatographer coupled to an ISQ mass spectrometer system set-up at selected ion monitoring mode. Thermo Scientific TR-5MS column (30 mm×0.25 mm) with 0.25 μm film thickness was used for separation of benzene and toluene during the GC-MS run. Each solvent (analytical grade) was dissolved into water to prepare stock solution of 50 μg/mL. The stock solution was further diluted to make calibration solutions of 10 ng/ml, 5 ng/ml, 2.5 ng/ml, 1.25 ng/ml and 0.62 ng/ml for both solvents. As above, coated substrates (75 mm×25 mm) were dipped into 50 ml of 10 ng/ml solutions and the collected sample were injected into the GC-MS system at pre-determined time intervals of 10 min, 30 min, 1 hr, 2 hrs and 4 hrs at 25° C.

The adsorption of dye (rhodamine B) and organic compounds (benzene and toluene) was followed over time using UV-Vis and GC-MS spectroscopy and the results are presented in FIG. 38. Since the weight of adsorbent (MOFs) is unknown, the adsorption capacity is calculated simply as the difference of initial concentration and remaining concentration of the pollutant in the solution. The area of the substrate for adsorption experiments was 18.75 cm². As shown in FIG. 38, the evolution of dye (rhodamine B) adsorption is slightly different from those of benzene and toluene. In case of rhodamine B, a significant increase in the adsorption was observed in the first 60 minutes followed by stabilisation whereas, the maximum adsorption of benzene and toluene occurred within the first 10 minutes. The adsorption of rhodamine can also be clearly observed with naked eye. However, for better understanding of the adsorption process, the results were fitted in pseudo-second-order kinetics:

$$\frac{t}{{q}_{t}} = \frac{1}{{kq}_{e}^{2}} + \frac{t}{{q}_{e}} t$$

where qₜ is the adsorption capacity at time t, qₑ at equilibrium, and k is the rate constant of pseudo second order kinetics.

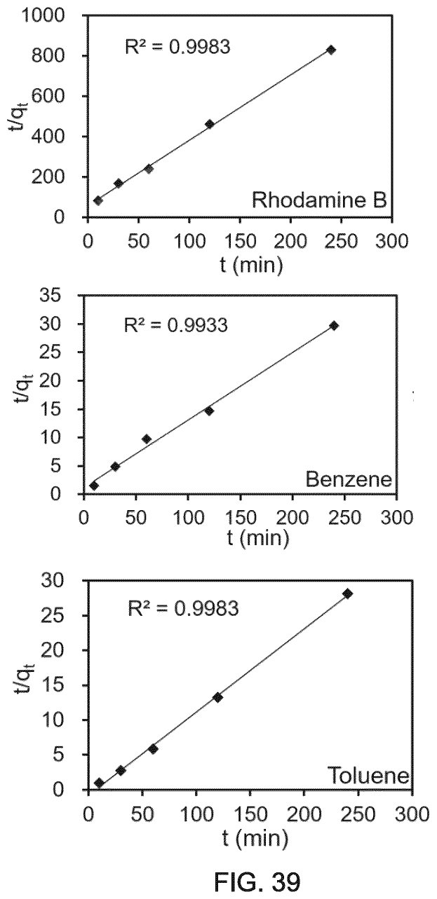

The results fit the pseudo-second-order kinetic model very well (R²>0.99, see FIG. 39), which seems to indicate single-step surface adsorption with chemisorption being the rate limiting step.

The inherent adsorption efficacy of MOFs was exploited to demonstrate the potential of nanohierarchical MOF surfaces according to Example 4 showed excellent and quick adsorption of rhodamine B (˜0.77 μg/cm²), benzene (˜21.7 ng/cm²) and toluene (˜29.2 ng/cm²) (FIGS. 38 and 39).

### REFERENCES

A number of publications are cited above in order to more fully describe and disclose the invention and the state of the art to which the invention pertains. Full citations for these references are provided below. The entirety of each of these references is incorporated herein.

Chapman, S. P.; Hong, J. K.; Waterhouse, A.; Neto, C. Life and death of liquid-infused surfaces: a review on the choice, analysis and fate of the infused liquid layer. Chem. Soc. Rev., 2020, 49, 3688-3715.

Chen, W.; Zhang, P.; Zang, R.; Fan, J.; Wang, S.; Wang, B.; Meng, J. Underwater superoleophobicity: nacre-inspired mineralized films with high transparency and mechanically robust underwater superoleophobicity. Adv. Mater. 2020, 32, 1907413.

Dang, S.; Zhu, Q. L.; Xu, Q. Nanomaterials derived from metal-organic frameworks. Nat. Rev. Mater. 2018, 3, 17075.

Deng, X.; Mammen, L.; Butt, H. J.; Vollmer, D. Candle soot as a template for a transparent robust superamphiphobic coating. Science, 2012, 335, 70.

Gao, J.; Zhang, Y.; Wei, W.; Yin, Y.; Liu, M.; Guo, H.; Zheng, C.; Deng, P. Liquid-infused micro-nanostructured MOF coatings (LIMNSMCs) with high anti-icing performance. ACS Appl. Mater. Interfaces 2019, 11, 47545-47552.

Jayaramaulu, K.; Geyer, F.; Schneemann, A.; Kment, S.; Oteypka, M.; Zboril, R.; Vollmer, D.; Fischer, R. A. Hydrophobic metal-organic frameworks. Adv. Mater. 2019, 31, 1900820.

Kalmutzki, M. J.; Hanikel, N.; Yaghi, O. M. Secondary building units as the turning point in the development of the reticular chemistry of MOFs. Sci. Adv. 2018, 4, eaat9180.

Li, X.; Wang, D.; Tan, Y.; Yang, J.; Deng, X.; Designing transparent micro/nano re-entrant-coordinated superamphiphobic surfaces with ultralow solid/liquid adhesion. ACS Appl. Mater. Interfaces, 2019, 32, 29465.

Maitra, T.; Tiwari, M. K.; Antonini, C.; Schoch, P.; Jung, S.; Eberle, P.; Paulikakos, D. On the nanoengineering of superhydrophobic and impalement resistant surface textures below the freezing temperature. Nano Lett. 2014, 1, 182.

Mukherjee, S.; Sharma, S., Ghosh, S. K. Hydrophobic metal-organic frameworks: Potential toward emerging applications. APL Mater. 2019, 7, 050701.

Peng, C.; Chen, Z.; Tiwari, M. K. All-organic superhydrophobic coatings with mechanochemical robustness and liquid impalement resistance. Nat. Mater., 2018. 17, 355-360.

Redfern, L. R.; Farha, O. K. Mechanical properties of metal-organic frameworks. Chem. Sci. 2019, 10, 10679.

Roy, S.; Suresh, V. M.; Maji, T. K. Self-cleaning MOF: realization of extreme water repellence in coordination driven self-assembled nanostructures. Chem. Sci. 2016, 7, 2251.

Sun, D.; Adiyala, P. R.; Yim, S-J.; Kim, D-P.; Pore-surface engineering by decorating metal-oxo nodes with phenylsilane to give versatile super-hydrophobic metal-organic frameworks (MOFs). Angew. Chem. Int. Ed. 2019, 58, 7405 -7409.

Teisala, H.; Geyer, F.; Haapanen, J.; Juuti, P.; Makela, J. M.; Vollmer, D.; Butt, H. J. Ultrafast processing of hierarchical nanotexture for a transparent superamphiphobic coating with extremely low roll-off angle and high impalement pressure. Adv. Mater. 2018, 30, 1706529.

Wang, L.; McCarthy T. J., Covalently attached liquids: instant omniphobic surfaces with unprecedented repellency. Angew. Chem. Int. Ed. 55, 244-248 (2016).

Wang, D.; Sun, Q.; Hokkanen, M. J.; Zhang, C.; Lin, F. Y.; Liu, Q.; Zhu, S. P.; Zhou, T.; Chang, Q.; He, B.; Zhou, Q.; Chen, L.; Wang, Z.; Ras, R. H. A.; Deng, X. Design of robust superhydrophobic surfaces. Nature, 2020, 582, 59.

Wu, H.; Yildirim, T.; Zhou. W. Exceptional mechanical stability of highly porous zirconium metal-organic framework UiO-66 and its important implications. J. Phys. Chem. Lett. 2013, 6, 930.

Xiao, Y-H.; Gu, Z-G.; Zhang, J. Surface-coordinated metal-organic framework thin films (SURMOFs) for electrocatalytic applications. Nanoscale, 2020, 12, 12712-12730.

Yong, J.; Chen, F.; Yang, Q.; Huo, J.; Hou, X. Superoleophobic surfaces. Chem. Soc. Rev. 2017, 46, 4217.

1. A substrate having an amphiphobic surface coating, the surface coating comprising a Metal-Organic Framework (MOF) film wherein:
(i) a first surface of the MOF film is bonded to the substrate;
(ii) a second surface of the MOF film is an outer surface, functionalized with a plurality of surface functionalization groups;
wherein:
the MOF film comprises a MOF, the MOF having:
metal ions selected from ions of Zr, Al, Fe, Cr and Ti; and
multivalent linker groups having a structure according to formula (I): 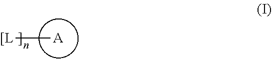
wherein A is a C₅₋₂₆ aryl group, optionally substituted with one or more groups selected from amino, halo, hydroxyl, nitro, azido, and C₂₋₄ alkynyl and cyclooctynyl;
L is a ligation group, each independently selected from carboxyl, hydroxyl and 5- or 6-membered heteroaryl having from 1 to 3 nitrogen heteroatoms; and
n is an integer number in the range 2 to 6;
the surface functionalization groups are covalently bonded to the second surface of the MOF film and are independently selected from C₁₋₄₀ alkyl groups optionally substituted with halo; C₅₋₂₀ carboaryl groups optionally substituted with C₁₋₆ alkyl and/or halo; C₅₋₂₀ cycloalkyl groups optionally substituted with C₁₋₆ alkyl and/or halo; silyl-C₁₋₄₀ alkyl groups optionally substituted with halo; and polydimethylsiloxane oligomers having from 5 to 50 repeating units;
the MOF film having an average thickness in the range 50-500 nm; and
the surface coating having an optical transmission of greater than 75% to light having a wavelength in the range 400-700 nm.

2. A substrate of claim 1, wherein the surface functionalization groups are selected from:
C₆₋₂₄ alkyl, C₆₋₁₀ carboaryl, C₆₋₁₀ cycloalkyl and silyl-C₆₋₂₄ alkyl groups;
wherein each of the carboaryl and cycloalkyl groups are optionally substituted with C₁₋₆ alkyl, and/or wherein each of the alkyl, carboaryl, cycloalkyl, and silyl alkyl are optionally substituted with halo.

3. A substrate of claim 2 wherein the surface functionalization groups are silyl-C₆₋₂₄ alkyl.

4. A substrate of claim 1, wherein the group A in formula (I) is selected from phenyl, naphthalene, biphenyl, fluorene, anthracene, phenanthrene, phenalene, terphenyl, tetracene, chrysene, triphenylene, pyrene, pentacene, perylene, benzo[a]pyrene, corannulene, and coronene.

5. A substrate of claim 1, wherein the ligation groups L are selected from carboxyl and hydroxyl; optionally wherein the integer n is 2 or 3.

6. A substrate of claim 1, wherein the multivalent linker groups are selected from: 2,5-dihydroxy-1,4-benzenedicarboxylic acid, 2,5-diamino-1,4-benzenedicarboxylic acid, 2,2′-dihydroxy-4,4′-biphenyldicarboxylic acid, 3,3′-dihydroxy-4,4′-biphenyldicarboxylic acid, 2,2′-diamino-4,4′-biphenyldicarboxylic acid, 3,3′-amino-4,4′-biphenyldicarboxylic acid, 2,2″-dihydroxy-p-terphenyl-4,4″-dicarboxylic acid, 2,2″-diamino-p-terphenyl-4,4″-dicarboxylic acid, 3,3″-dihydroxy-p-terphenyl-4,4″-dicarboxylic acid, 3,3″-diamino-p-terphenyl-4,4″-dicarboxylic acid, and 2′,5′-dihydroxy-[1,1′:4′,1″]-terphenyl-4,4″-dicarboxylic acid.

7. A substrate of claim 1, wherein the MOF is selected from:
Zr(UiO-66-OH) [that is, Zr⁴⁺ with 2,5-dihydroxy-1,4-benzenedicarboxylic acid linker],
Zr(UiO-66-NH₂) [that is, Zr⁴⁺ with 2,5-diamino-1,4-benzenedicarboxylic acid linker],
Zr(UiO-67-OH) [that is, Zr⁴⁺ with 3,3′-dihydroxy-4,4′-biphenyldicarboxylic acid linker],
Zr(UiO-67-NH2) [that is, Zr⁴⁺ with 3,3′-amino-4,4′-biphenyldicarboxylic acid linker],
Zr(UiO-68-OH) [that is, Zr⁴⁺ with 3,3″-dihydroxy-p-terphenyl-4,4″-dicarboxylic acid linker], and
Zr(UiO-68-NH2) [that is, Zr⁴⁺ with 3,3″-diamino-p-terphenyl-4,4″-dicarboxylic acid linker].

8. A substrate of claim 1, wherein the surface coating has an average thickness in the range 60-400 nm, 70-300 nm, 100-250 nm, or 150-200 nm.

9. A substrate of claim 1, wherein the MOF has an average pore size of less than 3 nm.

10. A substrate of claim 1, wherein the root mean square roughness of the coating layer is in the range 50-150 nm.

11. A substrate of claim 1, wherein the surface coating comprises from 4-9 MOF layers.

12. A substrate of claim 1, wherein the substrate is a clear optical component.

13. A method of producing a substrate having an amphiphobic surface coating, the method comprising the following steps, in order:
(i) providing a substrate;
(ii) forming a first MOF layer which is bonded to the substrate;
(iii) removing unreacted reagents;
(iv) forming a further MOF layer on the existing MOF layer;
(v) removing unreacted reagents;
(vii) contacting the MOF film with a surface functionalization reagent to covalently bond surface functionalization groups to the outer surface MOF layer of the MOF film;
each MOF layer comprising a MOF, the MOF having:
metal ions selected from ions of Zr, Al, Fe, Cr and Ti; and
multivalent linker groups having a structure according to formula (I): 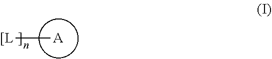
wherein A is a C₅₋₂₆ aryl group, optionally substituted with one or more groups selected from amino, halo, hydroxyl, nitro, azido, and C₂₋₄ alkynyl and cyclooctynyl;
L is a ligation group, each independently selected from carboxyl, hydroxyl and 5- or 6-membered heteroaryl having from 1 to 3 nitrogen heteroatoms; and
n is an integer number in the range 2 to 6;
the surface functionalization groups being independently selected from C₁₋₄₀ alkyl groups optionally substituted with halo; C₅₋₂₀ carboaryl groups optionally substituted with C₁₋₆ alkyl and/or halo; C₅₋₂₀ cycloalkyl groups optionally substituted with C16 alkyl and/or halo; silyl-C₁₋₄₀ alkyl groups optionally substituted with halo; and polydimethylsiloxane oligomers having from 5 to 50 repeating units.

14. A method of claim 13, wherein the steps (iii) and (v) comprise washing the MOF layer with a solvent and sonicating the MOF layer in a solvent.

15. A method of claim 13, wherein the steps (iv) and (v) are repeated two or more times to form a MOF film having three or more MOF layers, prior to performing step (vii).
